(19) United States
(12) Patent Application Publication
(10) Pub. No.: US 2024/0404455 A1
(43) Pub. Date: Dec. 5, 2024

(54) DISPLAY DRIVING CIRCUIT, DISPLAY DEVICE, AND DISPLAY SYSTEM

(71) Applicant: Samsung Electronics Co., Ltd., Suwon-si (KR)

(72) Inventors: Hongki KWON, Suwon-si (KR); Taewoo KIM, Suwon-si (KR); Jinyong PARK, Suwon-si (KR); Hyunwook LIM, Suwon-si (KR); Hojun CHUNG, Suwon-si (KR)

(73) Assignee: Samsung Electronics Co., Ltd., Suwon-si (KR)

(21) Appl. No.: 18/670,839

(22) Filed: May 22, 2024

(30) Foreign Application Priority Data
May 31, 2023 (KR) 10-2023-0070035
Mar. 5, 2024 (KR) 10-2024-0031495

(51) Int. Cl. G09G 3/32; G06F 3/01

(52) U.S. Cl. CPC G09G 3/32; G06F 3/013; G09G 2310/0267; G09G 2310/0275; G09G 2310/08; G09G 2330/021; G09G 2340/0407; G09G 2354/00; G09G 2360/12

(57) ABSTRACT

A display device including a host interface circuit configured to receive first frame data through a first signal channel and second frame data through a second signal channel, a pixel array including a plurality of pixels, and a plurality of gate lines and a plurality of source lines connected to the plurality of pixels, and an image processing circuit configured to process the first frame data and the second frame data such that the pixel array displays one image including a first area rendered with a first quality and a second area rendered with a second quality that is different from the first quality during one frame period.

### CROSS-REFERENCE TO RELATED APPLICATIONS

This application claims priority to and the benefit of, under 35 U.S.C. § 119, Korean Patent Application No. 10-2023-0070035 filed in the Korean Intellectual Property Office on May 31, 2023, and Korean Patent Application No. 10-2024-0031495 filed in the Korean Intellectual Property Office on Mar. 5, 2024, the entire contents of each of which are incorporated herein by reference.

### BACKGROUND

### 1. Field

Example embodiments relate to a display driving circuit, a display device, and a display system.

### 2. Description of Related Art

To provide a virtual reality (VR) and an augmented reality (AR), near to eye (NTE) display devices are used. The near-eye (NTE) display devices are mounted on wearable devices and provide magnified images to a user through an optical system. Near-eye display devices are equipped with a micro display that can display high-resolution images so that pixels are not recognized despite being small in size.

The video encoding system of the wearable device may perform foveated rendering, which reduces a resolution in a peripheral area for a frame data while maintaining higher resolution in a foveated area. The foveated rendered images are divided into low-resolution images and high-resolution images, and the micro display may receive the low-resolution images and the high-resolution images through one transmission channel and display the foveated images by mixing two images.

### SUMMARY

Some example embodiments provide a display driving circuit, a display device, and a display system that may be configured to transmit or send a high resolution image according to a mixing timing of a low resolution image and a high resolution image in the display device.

Some example embodiments provide a display driving circuit, a display device, and a display system that may not include a buffer memory.

Some example embodiments provide a display driving circuit, a display device, and a display system that may reduce an interface bandwidth.

A display device according to some example embodiments includes a host interface circuit configured to receive first frame data through a first signal channel and second frame data through a second signal channel, a pixel array including a plurality of pixels, and a plurality of gate lines and a plurality of source lines connected to the plurality of pixels, and an image processing circuit configured to process the first frame data and the second frame data such that the pixel array displays one image including a first area rendered with a first quality and a second area rendered with a second quality that is different from the first quality during one frame period.

A display system according to some example embodiments includes a host device configured to send first frame data rendered with a first quality and second frame data rendered with a second quality different from the first quality through a first signal channel and a second signal channel, or send combination frame data combining the first frame data and the second frame data through one of the first signal channel and the second signal channel, and a display device configured to display an image of one frame based on the first frame data and the second frame data received through the first signal channel and the second signal channel, or display an image of one frame based on the combination frame data received through one of the first signal channel and the second signal channel.

A display driving circuit according to some example embodiments includes a host interface circuit configured to receive first frame data through a first signal channel and receive second frame data through a second signal channel, or receive combination frame data combining the first frame data and the second frame data through one of the first signal channel and the second signal channel, a decoder configured to receive the combination frame data and output the first frame data and the second frame data, a scaler for up-scaling the second frame data, a mixer configured to output synthesis frame data mixing the up-scaled second frame data and the first frame data, and a timing controller configured to generate a data signal based on the synthesis frame data.

### BRIEF DESCRIPTION OF THE DRAWINGS

FIG. 1 is an example block diagram of a display system according to some example embodiments.

FIG. 2 is a block diagram showing a part of a display system according to some example embodiments.

FIG. 3 is a view showing an image displayed by a display device according to some example embodiments.

FIG. 4 is a timing diagram showing timings related to a frame data in a display system according to some example embodiments.

FIG. 5 is a view showing an example of a frame data in a display system according to some example embodiments.

FIG. 6 is a block diagram showing a part of a display system according to some example embodiments.

FIG. 7 is a timing diagram showing timings related to a frame data in a display system according to some example embodiments.

FIG. 8 is a view showing an example of a frame data in a display system according to some example embodiments.

FIG. 9 is a block diagram showing a part of a display system according to some example embodiments.

FIG. 10 is a block diagram showing a part of a display system according to some example embodiments.

FIG. 11 is a timing diagram showing timings related to a frame data in a display system according to some example embodiments.

FIG. 12 is a view showing an example of a frame data in a display system according to some example embodiments.

FIG. 13 is a timing diagram showing timings related to a frame data in a display system according to some example embodiments.

FIG. 14 is a view showing an example of a frame data in a display system according to some example embodiments.

FIG. 15 is a timing diagram showing timings related to a frame data in a display system according to some example embodiments.

FIG. 16A is a view showing an example of a frame data in a display system according to some example embodiments.

FIG. 16B is a view showing an example of generating a combined frame data in a display system according to some example embodiments.

FIG. 17 is a block diagram showing a part of a display driving circuit according to some example embodiments.

FIG. 18 is a view showing an example of a frame data in a display system according to some example embodiments.

FIG. 19 is a block diagram showing a part of a display system according to some example embodiments.

FIG. 20 is a block diagram showing a part of a display driving circuit according to some example embodiments.

FIG. 21 is a timing diagram showing timings related to a frame data in a display system according to some example embodiments.

FIG. 22 is a block diagram showing a part of a display driving circuit according to some example embodiments.

FIG. 23 is a view to explain a display system according to some example embodiments.

### DETAILED DESCRIPTION

In the following detailed description, only some example embodiments of the present inventive concepts have been shown and described, simply by way of illustration. As those skilled in the art would realize, the described example embodiments may be modified in various different ways, all without departing from the spirit or scope of the present inventive concepts.

Accordingly, the drawings and description are to be regarded as illustrative in nature and not restrictive. Like reference numerals designate like elements throughout the specification. The sequence of operations or steps is not limited to the order presented in the claims or figures unless specifically indicated otherwise. The order of operations or steps may be changed, several operations or steps may be merged, a certain operation or step may be divided, and a specific operation or step may not be performed.

As used herein, the singular forms “a” and “an” are intended to include the plural forms as well, unless the context clearly indicates otherwise. Terms including ordinal numbers such as first, second, and the like will be used only to describe various components, and are not to be interpreted as limiting these components. These terms may be used for the purpose of distinguishing one constituent element from other constituent elements.

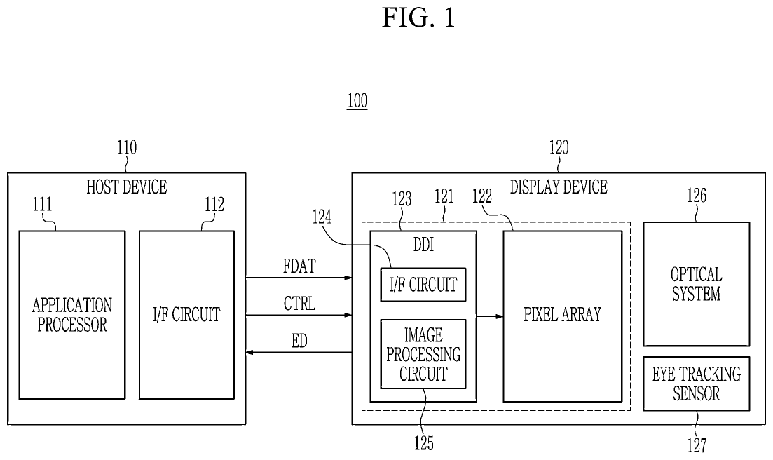

FIG. 1 is an example block diagram of a display system according to some example embodiments.

The display system 100 may provide an artificial reality system, for example, a VR (virtual reality) system, an AR (augmented reality) system, a mixed reality (MR) system, a hybrid reality system, or some combination thereof and/or a derived system. The artificial reality system may be implemented on a variety of platforms, including head mounted displays (HMDs), mobile devices, computing systems, and/or other hardware platforms that can provide artificial reality content to one or more viewers. The display system 100 may include a display device 120 and a host device 110 (also referred to as “a source device”).

The host device 110 may be a computing device or a system that controls the display device 120 to display an image desired by a user on a pixel array 122 from an outside. The host device 110 may transmit or send frame data FDAT according to (e.g., based on) contents to be presented to the user to the display device 120. In some example embodiments, the host device 110 may render contents generated when an application is executed as the frame data FDAT including a plurality of areas with different display qualities. For example, the image according to the frame data FDAT may include a first area and a second area, the first area may be rendered with a first quality (e.g., a high resolution), and the second area around the first area may be rendered with a second quality (e.g., a low resolution). In some example embodiments, the frame data FDAT may include a high resolution frame data rendered with the first quality and a low resolution frame data rendered with the second quality. In some example embodiments, the frame data FDAT may include a high resolution frame data in which the first area is rendered with the first quality and a low resolution frame data in which the second area excluding the first area is rendered with the second quality.

The host device 110 may transmit or send the high resolution frame data and the low resolution frame data to the display device 120 through one signal channel. In some example embodiments, the host device 110 may transmit or send the high resolution frame data and the low resolution frame data to the display device 120 through a plurality of signal channels. For example, the low resolution frame data may be transmitted or sent through the first signal channel among the plurality of signal channels, and the high resolution frame data may be transmitted or sent through the second signal channel among the plurality of signal channels.

In some example embodiments, the host device 110 may transmit or send the high resolution frame data and the low resolution frame data to the display device 120 through a plurality of signal channels, and transmit or send a combination frame data of which the high resolution frame data and the low resolution frame data are combined through one signal channel to the display device 120. For example, the host device 110 may transmit or send the high resolution frame data and the low resolution frame data through the plurality of signal channels based on the data size of the high resolution frame data and/or the data size of the low resolution frame data, or may transmit or send the combination frame data through one signal channel. For example, if the size of the combination frame data is less than the bandwidth of the signal channel, the host device 110 may transmit or send the combination frame data through one signal channel. The combination frame data may be a combination of the high resolution frame data in which the first area is rendered with the first quality and the low resolution frame data in which the second area excluding the first area is rendered with the second quality.

In some example embodiments, the host device 110 may transmit or send the first combination frame data and the second combination frame data to the display device 120 through the plurality of signal channels, respectively, and transmit or send a third combination frame data, which is a combination of the high resolution frame data and the low resolution frame data, to the display device 120 through one signal channel. For example, the host device 110, based on the data size of the high resolution frame data and/or the data size of the low resolution frame data, may transmit or send the first combination frame data and the second combination frame data through the plurality of signal channels, respectively, or the third combination frame data through one signal channel. For example, if the size of the third combination frame data is less than the bandwidth of the signal channel, the host device 110 may transmit or send the third combination frame data through one signal channel. The third combination frame data may be a combination of the high resolution frame data in which the first area is rendered with the first quality and the low resolution frame data in which the second area excluding the first area is rendered with the second quality. The first and second combination frame data may be types that are divided from the third combination frame data. For example, the first combination data may be a combination of the high resolution frame data in which a part of the first area is rendered with the first quality and the low resolution frame data in which a part of the second area excluding the first area is rendered with the second quality. The second combination data may be a combination of the high resolution frame data in which another part of the first area is rendered with the first quality and the low resolution frame data in which another part of the second area excluding the first area is rendered with the second quality.

The host device 110 may include an application processor 111 that generates the frame data FDAT. In some example embodiments, the application processor 111 may generate the frame data FDAT including the plurality of areas with the different display qualities. In some example embodiments, the application processor 111 may perform the rendering of the frame data FDAT based on eye tracking data ED received from the display device 120. The application processor 111 may receive the eye tracking data ED from an eye tracking sensor 127 and may determine the position of the user's eyes based on the eye tracking data ED. For example, the application processor 111 may render the first area corresponding to the position of the user's eyes with the first quality, and render the second area surrounding the first area with the second quality.

The host device 110 may transmit or send a driving control signal CTRL to the display device 120. The driving control signal CTRL may include control instructions, predetermined data, etc., for controlling a driving circuit 123 and the optical system 126. In some example embodiments, the driving control signal CTRL may include area position information indicating the plurality of areas of the image according to the frame data FDAT. In some example embodiments, the area position information may include information about the number of the plurality of areas and/or coordinate data, function data, etc., indicating the positions of the plurality of areas within the image displayed by the frame data FDAT. For example, if the image displayed by frame data FDAT is divided into the first area and the second area and the first area has a rectangular shape, the area position information may include the coordinate values of four vertices of the first area.

The host device 110 may include a display interface circuit 112 for communication with the display device 120. The display interface circuit 112 may transmit or send the driving control signal CTRL and the frame data FDAT to the display device 120. In some example embodiments, the display interface circuit 112 may be implemented based on one of various standards, such as a mobile industry processor interface (MIPI), a high definition multimedia interface (HDMI), a display port (DP), a low power display port (LPDP), and an advanced low power display port (ALPDP), but example embodiments are not limited thereto.

The display device 120 may receive the frame data FDAT transmitted or sent from the host device 110 and may display the image according to the frame data FDAT. The display device 120 may display a 2D (two-dimensional) or 3D (three-dimensional) image to the user. The display device 120 may include a display panel 121, an optical system 126, and an eye tracking sensor 127. In some example embodiments, the display device 120 may further include a power supply circuit such as a DC/DC converter that provides a driving voltage to the display panel 121, the optical system 126, and the eye tracking sensor 127.

In some example embodiments, the display panel 121 may display the image to the user according to the frame data FDAT received from the host device 110. In some example embodiments, there may be one or more display panels 121. For example, two display panels 121 may provide images for each eye of the user. The display panel 121 may be a liquid crystal display (LCD), an organic light-emitting diode (OLED) display, an inorganic light emitting diode (ILED) display, a micro light emitting diode (uLED) display, an active matrix OLED display (AMOLED), and a transparent OLED display. (TOLED: transparent OLED), etc., but example embodiments are not limited thereto.

In some example embodiments, the display panel 121 may include a pixel array 122 and a driving circuit IC (DDI) 123. The display panel 121 may have a backplane structure in which a pixel array 122 and a driving circuit 123 are arranged on a silicon semiconductor substrate. For example, the display panel 121 may include the pixel array 122 and the driving circuit 123 on a complementary metal-oxide-semiconductor (CMOS) wafer.

The pixel array 122 may include a plurality of pixels, and a plurality of gate lines and a plurality of source lines connected to the plurality of pixels, respectively. In some example embodiments, the plurality of pixels may emit light of a predominant color, such as red, green, and blue, white, or yellow.

The driving circuit 123 may generate a signal that drives the pixel array 122 based on the frame data FDAT received from the host device 110. The signal driving the pixel array 122 may be transmitted or sent to the plurality of pixels through the plurality of gate lines and the plurality of source lines. In some example embodiments, the driving circuit 123 may generate gate signals and data voltages that drive the plurality of pixels included in the pixel array 122, and provide the gate signals and the data voltages to the plurality of pixels. The plurality of pixels included in the pixel array 122 may emit the image light by the signals provided by the driving circuit 123. The driving circuit 123 may include an interface circuit 124 and an image processing circuit 125.

The interface circuit 124 may receive at least one frame data FDAT and transmit or send the frame data FDAT to the image processing circuit 125. For example, the interface circuit 124 may be implemented based on the same standard as the display interface circuit 112. For example, the interface circuit 124 may receive the first frame data through the first signal channel and the second frame data through the second signal channel.

The image processing circuit 125 may process at least one frame data FDAT for the pixel array 122 to display one image including an area (e.g., an area displaying the high resolution image) rendered with the first quality and an area (e.g., an area displaying a low resolution image) rendered with a second quality different from the first quality during one frame period. For example, the image processing circuit 125 may generate the low resolution frame data and the high resolution frame data based on at least one frame data FDAT, and display the low resolution frame data and the high resolution frame data on the display panel 121. In some example embodiments, the image processing circuit 125 may rearrange the low resolution frame data and the high resolution frame data from at least one frame data FDAT. In some example embodiments, the image processing circuit 125 may up-scale the low resolution frame data and mix the high resolution frame data and the up-scaled low resolution frame data.

The driving circuit 123 may drive the plurality of areas of the image displayed by the frame data FDAT in a plurality of manners. For example, driving circuit 123 may drive the first area, which displays the high resolution frame data, and the second area, which displays the low resolution frame data, in different ways. The driving circuit 123 may drive the second area in a multi gate line driving method. The first area may be an area displayed by the high resolution frame data, and the second area may be an area displayed by the low resolution frame data. In some example embodiments, according to the multi gate line driving method, the driving circuit 123 may provide the gate signal the pixel array 122 so as to differentiate the length of the horizontal period of the gate signal provided to the pixels displaying the first area from the length of the horizontal period of the gate signal provided to the pixels displaying the second area within the pixel array 122. For example, when inputting the data voltage to the pixels displaying the first area, the horizontal period of the gate signal provided to the pixels displaying the first area may be 1H, and when inputting the data voltage to the pixels displaying the second area, the horizontal period of the gate signal provided to the pixels displaying the second area may be ⅓H. In some example embodiments, according to the multi gate line driving method, the driving circuit 123 may provide the gate signals to the pixels displaying the first area so that the horizontal periods of the gate signals do not overlap, and may provide the gate signals to the pixels displaying the second area so that the horizontal periods of the gate signals overlap each other. For example, the driving circuit 123 may provide the gate signals to the pixels displaying the first area in a raster scan method when inputting the data voltage to the pixels displaying the first area within the pixel array 122, and provide the gate signals whose horizontal periods overlap each other to the pixels connected to the plurality of gate lines among the pixels displaying the second area when inputting the data voltage to the pixels displaying the second area.

In some example embodiments, according to the multi gate line driving method, the driving circuit 123 may drive the pixels adjacent to the pixels representing the first area among the pixels representing the second area, and the pixels positioned away from the pixels displaying the first area among the pixels displaying the second area. For example, the driving circuit 123 may determine whether is the pixels indicating the second area adjacent to or separated from the pixels indicating the first area, based on a distance, the number of the pixels, the number of the gate lines, etc. In some example embodiments, according to the multi gate line driving method, when inputting the data voltage to the pixels displaying the second area, the driving circuit 123 may apply the same data voltage to the pixels connected to the same gate line among the pixels displaying the second area. For example, when inputting the data voltage to the pixels displaying the second area, the driving circuit 123 may apply one among the plurality of data voltages corresponding to the pixels connected to the same gate lines and adjacent to each other among the pixels displaying the second area to the pixels connected to the same gate lines and adjacent to each other among the pixels displaying the second area as the same data voltage.

In some example embodiments, according to the multi gate line driving method, the driving circuit 123 may provide the gate signals whose horizontal periods overlap each other to a first gate line group, which includes the gate lines connected to the first pixel group among the pixels representing the second area, and the gate signals whose horizontal periods overlap each other to a second gate line group, which includes the gate lines connected to the second pixel group adjacent to the first pixel group among the pixels displaying the second area. The driving circuit 123 may be driven in a low bias state or turned off during a period from providing the gate signals to the first gate line group to providing the gate signals to the second gate line group. Accordingly, in some example embodiments, the driving circuit 123 may drive the pixels representing the second area discontinuously.

In some example embodiments, according to the multi gate line driving method, the driving circuit 123 may be driven in a low bias state or turned off during some sections of the scan period within one frame period. For example, the driving circuit 123 may be driven in a low bias state or turned off during a period corresponding to the number of the gate lines providing the gate signals so that the horizontal periods of the gate signals overlap each other. Accordingly, in some example embodiments, the driving circuit 123 may continuously drive the pixels that display the second area.

In some example embodiments, the display device 120 may identify the plurality of areas based on the area position information. For example, the display device 120 may identify the first area and the second area based on area position information, and drive the pixels displaying the first area and the pixels displaying the second area in different ways.

The image displayed on the display panel 121 may be recognized by the user's eyes through the optical system 126. In some example embodiments, the optical system 126 may optically display the image content or magnify an image light received from the display panel 121, correct optical errors associated with the image light, and provide the corrected image light to the user. For example, the optical system 126 may include a substrate, an optical waveguide, an aperture, a Fresnel lens, a convex lens, a concave lens, a filter, an input/output coupler, or other suitable optical elements that may affect the image light emitted from the display panel 121, but example embodiments are not limited thereto.

The eye tracking sensor 127 may track the position and motion of the user's eyes. Eye tracking may refer to determining the position of the eye, including the orientation and position of the eye relative to the display device 120. In some example embodiments, the eye tracking sensor 127 may include an imaging system for imaging one or more eyes. In some example embodiments, the eye tracking sensor 127 may include a light releasing group that produces light directed to the eye such that a light reflected by the eye may be captured by the imaging system. The eye tracking sensor 127 may transmit or send the eye tracking data ED to the host device 110.

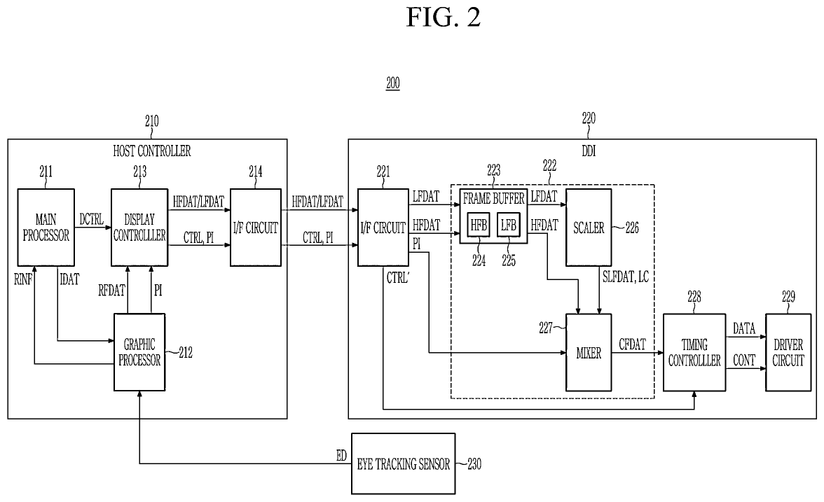

FIG. 2 is a block diagram showing a part of a display system according to some example embodiments.

Referring to FIG. 2, the display system 200 may include a host controller 210, a DDI 220, and an eye tracking sensor 230.

The host controller 210 may receive the eye tracking data ED from the eye tracking sensor 230, generate a first frame data HFDAT and a second frame data LFDAT, a driving control signal CTRL, and area position information PI based on the eye tracking data ED, and may transmit or send the first frame data HFDAT and the second frame data LFDAT, the driving control signal CTRL, and the area position information PI to the DDI 220.

The host controller 210 may include a main processor 211, a graphic processor 212, a display controller 213, and a display interface circuit 214. The main processor 211, the graphic processor 212, and the display controller 213 may include the application processor 111 of FIG. 1.

The main processor 211 may control the overall operation of the host controller 210. For example, the main processor 211 may run an operating system (OS). For example, the operating system may include a file system for file management and device drivers for controlling peripheral devices such as the display device (e.g., display device 120 illustrated in FIG. 1) at an operating system level. For example, the main processor 211 may include a CPU (Central Processing Unit), etc. The main processor 211 may generate and provide a display control signal DCTRL for controlling the display controller 213 and image data IDAT used to generate the frame data FDAT. In some example embodiments, the image data IDAT may be provided directly to the display controller 213, or the image data IDAT may be provided to the graphic processor 212, may be rendered by the graphic processor 212, and provided to the display controller 213 as rendering data RFDAT.

The graphic processor 212 may render the images displayed on the display device 120. For example, the graphic processor 212 may perform foveated rendering based on the image data IDAT and the eye tracking data ED to generate the rendering data RFDAT and the area position information PI, and may generate rendering information RINF related to the rendering operation. For example, the rendering information RINF may include the rendering speed of the graphic processor 212. The graphic processor 212 may provide the rendering data RFDAT and the area position information PI to the display controller 213, and may provide the rendering information RINF to the main processor 211. The graphic processor 212 may include a GPU (Graphics Processing Unit), etc.

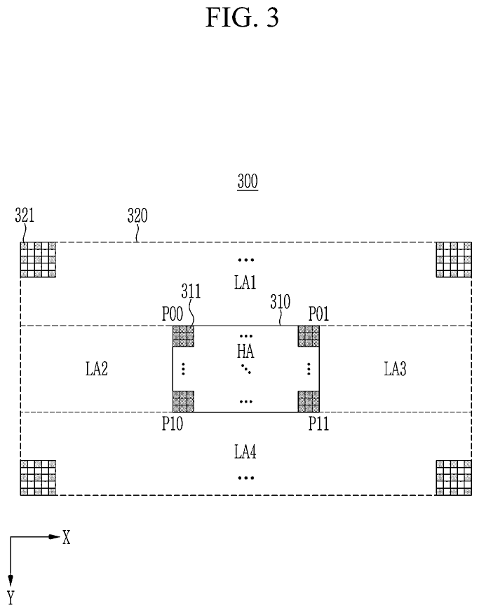

The display controller 213 may be controlled by the main processor 211 and may control the operation of the DDI 220. The display controller 213 may generate the driving control signal CTRL based on the display control signal DCTRL, and the frame data HFDAT and LFDAT based on the image data IDAT or the rendering data RFDAT. The driving control signal CTRL, the area position information PI, and the frame data HFDAT and LFDAT may be provided to the DDI 220. The display controller 213 may also be referred to as a DPU (Display Processing Unit). In some example embodiments, the display controller 213 may generate the first frame data HFDAT and the second frame data LFDAT based on the rendering data RFDAT. The first frame data HFDAT may include the high resolution frame data, and the second frame data LFDAT may include the low resolution frame data. The display device 120 may display the first frame data HFDAT and the second frame data LFDAT during one frame period. This is described with reference to FIG. 3 together.

FIG. 3 is a view showing an image displayed by a display device according to some example embodiments.

Referring to FIG. 3, the image 300 may include a first area 310 and a second area 320. The first area 310 may be an area rendered with the first quality, and the second area 320, around the first area 310, may be an area rendered with the second quality. In some example embodiments, the first area 310 may be an area surrounded by the second area 320. The position of the first area 310 may be indicated by the area position information PI. The area position information PI may indicate the position of the pixel data indicating the first area 310 within the frame data. The area position information PI may include coordinate values P00, P01, P10, and P11. The coordinate values P00, P01, P10, and P11 may each include an X-axis coordinate value and a Y-axis coordinate value. The first and second areas 310 and 320 each with the different rendering quality, may use arbitrary values, resolutions, or scales. In some example embodiments, the different rendering qualities of the first and second areas 310 and 320 may be changed dynamically. For example, the first area 310 and the second area 320 may be rendered at 4X and 1X quality, respectively. When the image 300 is displayed in the pixel array 122, each pixel displaying the first area 310 may display a high resolution image HA based on the corresponding pixel data 311. As for the pixels displaying the second area 320, four pixels may display the low resolution images LA1, LA2, LA3, and LA4 based on one pixel data 321.

In some example embodiments, if the user's gaze (e.g., a focus or a gaze position) is known based on the eye tracking data (e.g., ED of FIG. 1), the first area 310 may include a focus area where the user's gaze rests or is fixed. The size of the focus area may be based on the circular arc/angle covered by the user's line of the sight. For example, the circular arc covered by the line of the sight may be 20 degrees, or may be the circular arc/angle of 5 degrees to 20 degrees. Therefore, according to some example embodiments, the focus area may be based on the circular arc covered by the line of the sight and the viewing distance to the contents being rendered. In some example embodiments, the size of the focus area may be based on the amount of the movement of the user's gaze (e.g., an increasing movement increases the size).

Referring back to FIG. 2, the display interface circuit 214 may transmit or send the frame data HFDAT and LFDAT, the driving control signal CTRL, and the area position information PI to the DDI 220. The display interface circuit 214 may transmit or send the first frame data HFDAT and the second frame data LFDAT through one signal channel to display the image of one frame. In some example embodiments, the second frame data LFDAT and the first frame data HFDAT may be transmitted or sent sequentially through one signal channel.

The DDI 220 may receive the frame data HFDAT, LFDAT, the driving control signal CTRL, and the area position information PI, and may display the image on the pixel array 122 based on the frame data HFDAT, LFDAT, the driving control signal CTRL, and the area position information PI. The DDI 220 may include a host interface circuit 221, an image processing circuit 222, a timing controller 228, and a driver circuit 229.

The host interface circuit 221 may receive the first frame data HFDAT and the second frame data LFDAT, the driving control signal CTRL, and the area position information PI, and transmit or send the first frame data HFDAT, the second frame data LFDAT, and the area position information PI to the image processing circuit 222. The host interface circuit 221 may transmit or send the driving control signal CTRL to the timing controller 228. The host interface circuit 221 may transmit or send the driving control signal CTRL′, in which some synchronization signals among the driving control signals CTRL are delayed, to the timing controller 228. For example, the host interface circuit 221 may transmit or send the driving control signal CTRL′, which delays the vertical synchronization signal VSYNC and the horizontal synchronizing signal HSYNC of the driving control signal CTRL are delayed, to the timing controller 228.

The image processing circuit 222 may generate synthesis frame data CFDAT based on the first frame data HFDAT, the second frame data LFDAT, and the area position information PI, and output the synthesis frame data CFDAT to the timing controller 228. The image processing circuit 222 may include a frame buffer 223, a scaler 226, and a mixer 227. The frame buffer 223 may receive the first frame data HFDAT and the second frame data LFDAT and may temporarily store the first frame data HFDAT and the second frame data LFDAT. The frame buffer 223 may include a first frame buffer (HFB) 224 that stores the first frame data HFDAT and a second frame buffer (LFB) 225 that stores the second frame data LFDAT. The first frame data HFDAT stored in the first frame buffer 224 may be provided to the mixer 227. The second frame data LFDAT stored in the second frame buffer 225 may be provided to the scaler 226.

The scaler 226 may receive the second frame data LFDAT, up-scale the second frame data LFDAT, and output the up-scaled second frame data SLFDAT. The scaler 226 may perform the up-scaling for each line of the second frame data LFDAT. The scaler 226 may count the number of the lines of the second frame data LFDAT for which the up-scaling has been completed. The scaler 226 may transmit or send the line counting value LC to the mixer 227.

The mixer 227 may receive the up-scaled second frame data SLFDAT and the line counting value LC from the scaler 226, the first frame data HFDAT from first frame buffer 224, and the area position information PI from the host interface circuit 221. The mixer 227 may mix the up-scaled second frame data SLFDAT and the first frame data HFDAT based on the line counting value LC and the area position information PI. For example, when the mixer 227 compares the line counting value LC and the Y-axis coordinate value of the area position information PI and the line counting value LC and the Y-axis coordinate value match, based on the X-axis coordinate value of the area position information PI, the first frame data HFDAT may be synthesized to the second frame data SLFDAT. The mixer 227 may output the synthesis frame data CFDAT to the timing controller 228.

The timing controller 228 may generate the data signal DATA and the control signal CONT based on the synthesis frame data CFDAT and the driving control signal CTRL′. The driver circuit 229 may generate the plurality of data voltages and the plurality of scan signals provided to the pixel array 122 based on the data signal DATA and the control signal CONT. The pixel array 122 may display the foveated image based on the synthesis frame data CFDAT based on the plurality of data voltage and the plurality of scan signal.

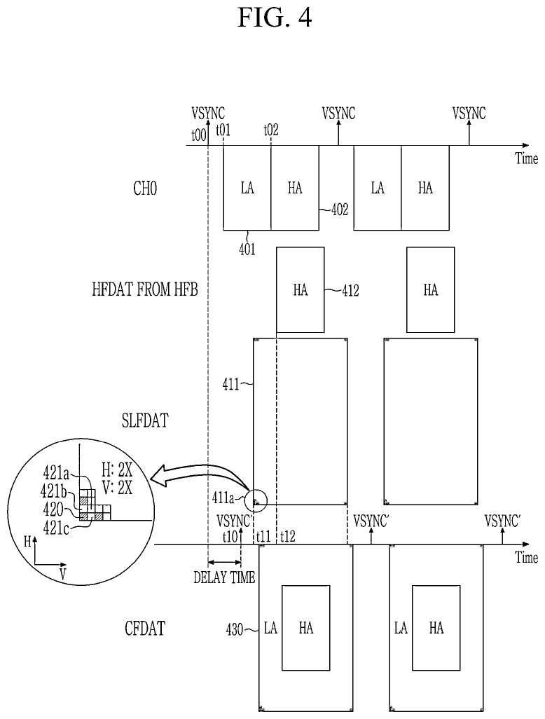

FIG. 4 is a timing diagram showing timings related to a frame data in a display system according to some example embodiments.

Referring FIG. 2 and FIG. to 4 together, a vertical synchronization signal VSYNC may be input at a time t00. One frame may be distinguished by the vertical synchronization signal VSYNC. The host interface circuit 221 may output a vertical synchronization signal VSYNC′ that the vertical synchronization signal VSYNC is delayed from the time t00 to a time t10 by the delay time DELAY TIME.

Through the signal channel CH0, the second frame data 401 may be input at the time t01, and the first frame data 402 may be input at a time t02. The scaler 226 may receive the second frame data 401 and up-scale the second frame data 401. The scaler 226 may output the up-scaled second frame data 411 at the time t11. The scaler 226 may up-scale the second frame data 401 by 2 times in the horizontal direction H and 2 times in the vertical direction Y. Referring to a part 411a of the up-scaled second frame data 411, one pixel data 420 of the first line of the second frame data 401 may be expanded to the horizontal direction H and the vertical direction Y. For example, based on the pixel data 420, three pixel data 421a, 421b, and 421c may be generated with the horizontal direction H and the vertical direction Y. The scaler 226 may output the line counting value LC of the up-scaled second frame data 411 to the mixer 227, and the mixer 227 may compare the line counting value LC and the area position information PI to read the first frame data 412 from the first frame buffer 224.

At a time t12, the delayed first frame data 412 may be output from the first frame buffer 224. The mixer 227 may output a synthesis frame data 430 by mixing the up-scaled second frame data 411 and the delayed first frame data 412.

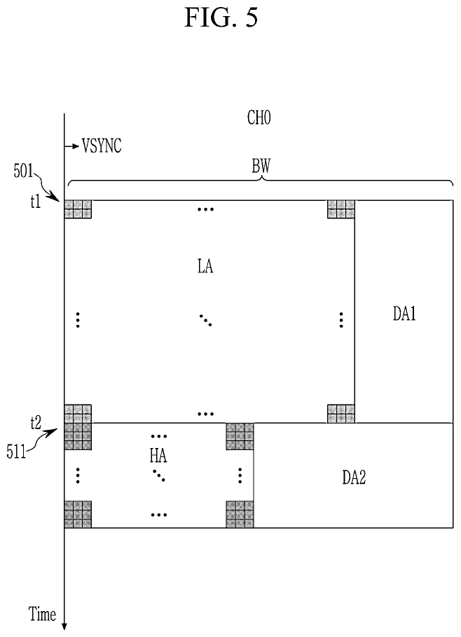

FIG. 5 is a view showing an example of a frame data in a display system according to some example embodiments.

Referring to FIG. 2 and FIG. 5, the second frame data LA and the first frame data HA may be sequentially input to the host interface circuit 221 through the signal channel CH0. At the time t1, the first line data 501 of the second frame data LA may be input. The second frame data LA may include the low resolution frame data obtained by rendering the image (e.g., 300 in FIG. 3) with a low resolution. The second frame data LA may include the pixel data corresponding to the entire area of the image 300.

The second frame data LA may have a size less than the bandwidth BW of the signal channel CH0. Therefore, in some example embodiments, the second frame data LA and dummy data DA1 may be transmitted or sent through the signal channel CH0.

At a time t2, the first frame data HA may be input. Depending on the size of the first area 310 in the image (e.g., 300 in FIG. 3), the first line data 511 of the first frame data HA may include the plurality of pixel data. The first frame data HA may also have a size less than the bandwidth BW of the signal channel CH0. Therefore, in some example embodiments, the first frame data HA and dummy data DA2 may be transmitted or sent through the signal channel CH0.

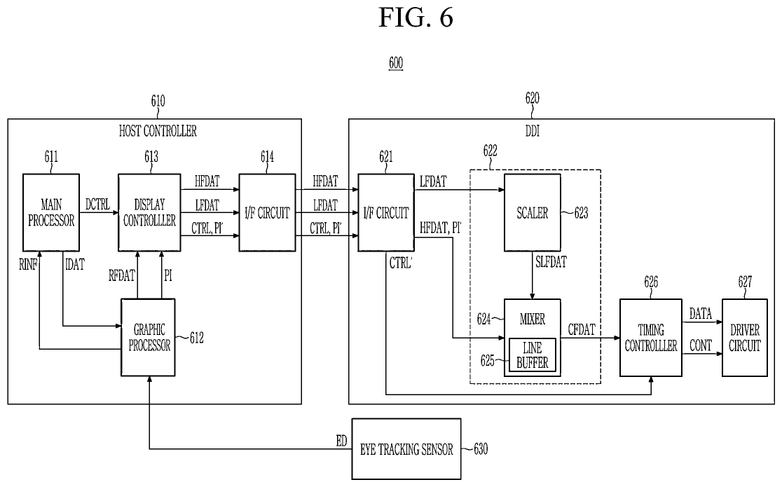

FIG. 6 is a block diagram showing a part of a display system according to some example embodiments.

Referring to FIG. 6, the display system 600 may include a host controller 610, a DDI 620, and an eye tracking sensor 630. Among the components of FIG. 6, the description of the components that are the same or similar to those in FIG. 2 is omitted.

The host controller 610 may receive the eye tracking data ED from the eye tracking sensor 630, generate the first frame data HFDAT and the second frame data LFDAT, the driving control signal CTRL, and the area position information PI based on the eye tracking data ED, and may transmit or send the first frame data HFDAT and the second frame data LFDAT, the driving control signal CTRL, and the area position information PI to the DDI 620.

The host controller 610 may include a main processor 611, a graphic processor 612, a display controller 613, and a display interface circuit 614. The main processor 611, the graphic processor 612, and the display controller 613 may be included in the application processor 111 of FIG. 1.

The main processor 611 may control the overall operation of the host controller 610. The main processor 611 may generate and provide a display control signal DCTRL for controlling the display controller 613 and an image data IDAT used to generate the frame data FDAT. For example, the image data IDAT may be provided directly to the display controller 613, or may be rendered by the graphic processor 612 to be provided to the display controller 613 as the rendering data RFDAT.

The graphic processor 612 may render the images displayed on the display device 120. For example, the graphic processor 612 may perform the foveated rendering based on the image data IDAT and the eye tracking data ED to generate the rendering data RFDAT and the area position information PI, and generate the rendering information RINF related to the rendering operation. For example, the rendering information RINF may include a rendering speed of the graphic processor 612. The graphic processor 612 may provide the rendering data RFDAT and the area position information PI to the display controller 613, and provide the rendering information RINF to the main processor 611.

The display controller 613 may be controlled by the main processor 611 and may control the operation of the DDI 620. The display controller 613 may generate the driving control signal CTRL based on the display control signal DCTRL, and the frame data HFDAT and LFDAT based on the image data IDAT or the rendering data RFDAT. The driving control signal CTRL and the frame data HFDAT, LFDAT may be provided to the DDI 620. In some example embodiments, the display controller 613 may generate the first frame data HFDAT and the second frame data LFDAT based on the rendering data RFDAT. The first frame data HFDAT may include the high resolution frame data, and the second frame data LFDAT may include the low resolution frame data. The display controller 613 may output some information PI′ among the area position information PI to the display interface circuit 614. For example, the area position information PI′ may include the X-axis coordinate values.

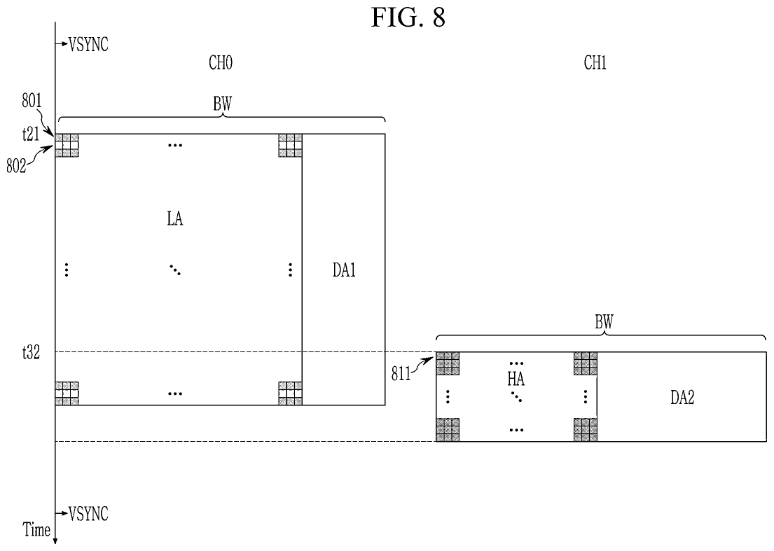

The display controller 613 may determine a mixing timing of two frame data HFDAT and LFDAT based on the area position information PI, and determine a transmission timing of two frame data HFDAT and LFDAT based on the determined mixing timing. The display controller 613 may insert dummy data between the line data of the second frame data LFDAT so that the second frame data LFDAT may be transmitted or sent with a relatively low speed. The display controller 613 may transmit or send the first frame data HFDAT in synchronization with the transmission timing for each line data of the second frame data LFDAT. This is described with reference to FIG. 8.

The display device 120 may display the first frame data HFDAT and the second frame data LFDAT during one frame period.

The display interface circuit 614 may transmit or send the frame data HFDAT, LFDAT, the driving control signal CTRL, and the area position information PI′ to the DDI 620. The display interface circuit 614 may transmit or send the first frame data HFDAT and the second frame data LFDAT through the plurality of signal channels to display the image of one frame. In some example embodiments, the second frame data LFDAT may be transmitted or sent through the first signal channel among the plurality of signal channels, and the first frame data HFDAT may be transmitted or sent through the second signal channel among the plurality of signal channels. In some example embodiments, at any point in time, the first frame data HFDAT and the second frame data LFDAT may be transmitted or sent together, or only one of the first frame data HFDAT and the second frame data LFDAT may be transmitted or sent.

The DDI 620 may receive the frame data HFDAT and LFDAT, the driving control signal CTRL, and the area position information PI′, and may display the image on the pixel array 122 based on the frame data HFDAT and LFDAT, the driving control signal CTRL, and the area position information PI′. The DDI 620 may include a host interface circuit 621, an image processing circuit 622, a timing controller 626, and a driver circuit 627.

The host interface circuit 621 may receive the first frame data HFDAT and the second frame data LFDAT, the driving control signal CTRL, and the area position information PI′, and may transmit or send the first frame data HFDAT, the second frame data LFDAT, and the area position information PI′ to the image processing circuit 622. The host interface circuit 621 may transmit or send the driving control signal CTRL to the timing controller 626. The host interface circuit 621 may transmit or send the driving control signal CTRL′, which some synchronization signals are delayed among the driving control signal CTRL, to the timing controller 626. For example, the host interface circuit 621 may transmit or send the driving control signal CTRL′, which the vertical synchronization signal VSYNC and the horizontal synchronizing signal HSYNC are delayed among the driving control signal CTRL to the timing controller 626.

The image processing circuit 622 may generate the synthesis frame data CFDAT based on the first frame data HFDAT, the second frame data LFDAT, and the area position information PI′, and output the synthesis frame data CFDAT to the timing controller 626. The image processing circuit 622 may include a scaler 623 and a mixer 624.

The scaler 623 may receive the second frame data LFDAT, up-scale the second frame data LFDAT, and output the scaled second frame data SLFDAT. The scaler 623 may perform the up-scaling for each line of the second frame data LFDAT. The scaler 623 may not perform the up-scaling on lines including dummy data. For example, the scaler 623 may not perform the upscaling on the dummy data inserted between valid line data.

The mixer 624 may receive the up-scaled second frame data SLFDAT from the scaler 623 and the first frame data HFDAT from the host interface circuit 621. The reception timing of the first frame data HFDAT may be substantially the same as the mixing timing of the first frame data HFDAT and the up-scaled second frame data SLFDAT. In some example embodiments, the mixer 624 may mix the received first frame data HFDAT and up-scaled second frame data SLFDAT in synchronization with the timing of receiving the up-scaled second frame data SLFDAT from the scaler 623. It will be understood that elements and/or properties thereof described herein as being “substantially” the same and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operation tolerance (e.g., +10%) around the stated elements and/or properties thereof. Further, when terms “about” or “substantially” are used in this specification in connection with a numerical value, it is intended that the associated numerical value include a tolerance of +10% around the stated numerical value.

In some example embodiments, the mixer 624 may include a line buffer 625. The line buffer 625 may temporarily store the line data of the up-scaled second frame data SLFDAT and the first frame data HFDAT. The mixer 624 may adjust the mixing timing of the up-scaled second frame data SLFDAT and the first frame data HFDAT through the line buffer 625.

The mixer 624 may mix the up-scaled second frame data SLFDAT and the first frame data HFDAT based on the area position information PI′. For example, the mixer 624 may synthesize the first frame data HFDAT to the second frame data SLFDAT based on the X-axis coordinate value of the area position information PI′. The mixer 624 may output the synthesis frame data CFDAT to the timing controller 626.

The timing controller 626 may generate the data signal DATA and the control signal CONT based on the synthesis frame data CFDAT and the driving control signal CTRL′.

The driver circuit 627 may generate the plurality of data voltages and the plurality of scan signals provided to the pixel array 122 based on the data signal DATA and the control signal CONT. The pixel array 122 may display the foveated image based on the synthesis frame data CFDAT based on the plurality of data voltages and the plurality of scan signals.

Compared to the display system 200 in FIG. 2, since the display system 600 of FIG. 6, according to some example embodiments, does not include the frame buffer 223 (illustrated in FIG. 2), an area overhead may be reduced and a power consumption for driving the frame buffer 223 may be prevented. In some example embodiments, since the host controller 610 transmits two frame data HFDAT and LFDAT in consideration of the mixing timing of two frame data HFDAT and LFDAT, the display system 600 of FIG. 6 may reduce a video latency due to the input/output of the frame buffer 223.

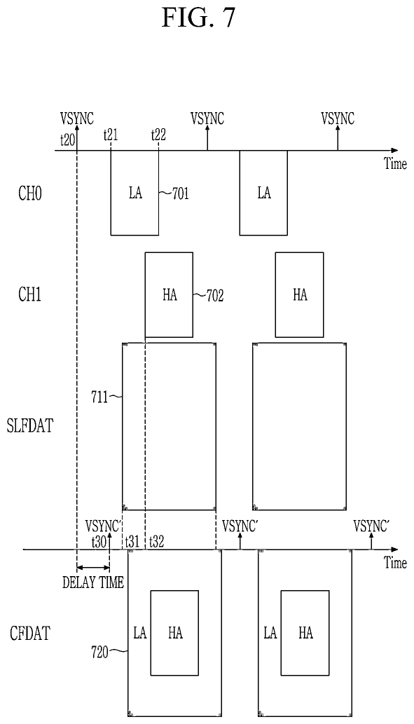

FIG. 7 is a timing diagram showing timings related to a frame data in a display system according to some example embodiments.

Referring to FIG. 6 and FIG. 7 together, at a time t20, the vertical synchronization signal VSYNC may be input. The host interface circuit 621 may output a vertical synchronization signal VSYNC′ that vertical synchronization signal VSYNC is delayed from the time t20 to a time t30 by a delay time DELAY TIME.

Through the first signal channel CH0, the second frame data 701 may be input at a time t21. The transmission of the second frame data 701 may be completed at a time t22. The scaler 623 may receive the second frame data 701 and up-scale the second frame data 701. The scaler 623 may output the up-scaled second frame data 711 at a time t31. The scaler 623 may up-scale the second frame data 701 by 2 times in the horizontal direction H and 2 times in the vertical direction Y. In synchronization with the mixing timing of the up-scaled second frame data 711 and the first frame data 702, the first frame data 702 may be input through the second signal channel CH1 at a time t32.

The mixer 624 may mix the up-scaled second frame data 711 and the first frame data 702 based on the area position information PI. The mixer 624 may output a synthesis frame data 720 by mixing the up-scaled second frame data 711 and the first frame data 702.

FIG. 8 is a drawing showing an example of a frame data in a display system according to some example embodiments.

Referring to FIG. 6 and FIG. 8, the second frame data LA may be input to the host interface circuit 621 through the first signal channel CH0, and the first frame data HA may be input to the host interface circuit 621 through the second signal channel CH1.

At the time t21, a first line data 801 of the second frame data LA may be input. The second frame data LA may have a size less than or equal to the bandwidth BW of the first signal channel CH0. Therefore, the second frame data LA and the dummy data DA1 may be transmit or sent through the first signal channel CH0.

In FIG. 8, it is assumed that the first frame data HA is rendered with 4× quality, and the second frame data LA is rendered with 1× quality. For example, the second frame data LA may be a rendered data so that a 3840×2160 resolution image is displayed as a 1920×1080 resolution image. The first line data 801 of the second frame data LA may include the 1920 pixel data that the first line data including the 3840 pixel data and the second line data including the 3840 pixel data are reduced by ¼, and the second line data 802 may include a dummy data. Hereby, compared to the second frame data LA of FIG. 5, the second frame data LA may be transmitted or sent relatively slowly.

As a time t32, a first line data 811 of the first frame data HA may be input. Depending on the size of the first area 310 in the image (300 in FIG. 3), the first line data 811 of the first frame data HA may include the plurality of pixel data. The first frame data HA may also have the size less than the bandwidth BW of the second signal channel CH1. Therefore, the first frame data HA and the dummy data DA2 may be transmitted or sent through the second signal channel CH1.

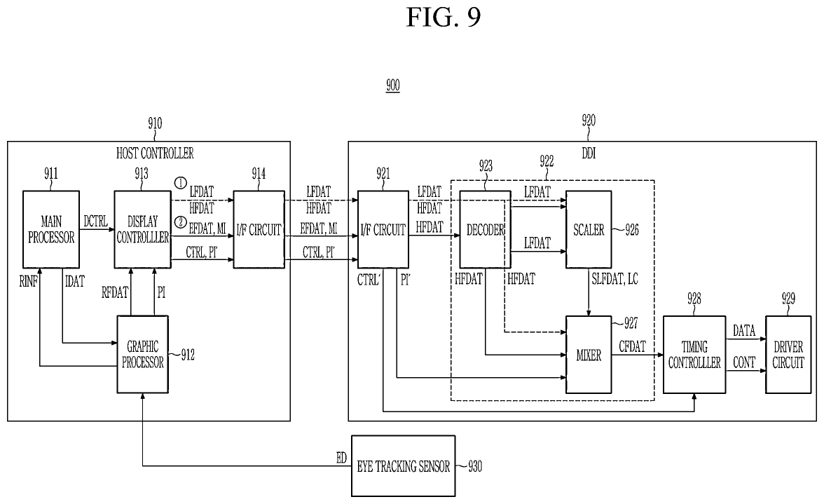

FIG. 9 is a block diagram showing a part of a display system according to some example embodiments.

Referring to FIG. 9, a display system 900 may include a host controller 910, a DDI 920, and an eye tracking sensor 930. Among the components of FIG. 9, the description of the components that are the same or similar to those in FIG. 2 and FIG. 6 is omitted.

The host controller 910 may receive the eye tracking data ED from the eye tracking sensor 930, generate the first frame data HFDAT and the second frame data LFDAT, the driving control signal CTRL, and the area position information PI based on the eye tracking data ED, and transmit or send the first and second frame data HFDAT and LFDAT/the combination frame data EFDAT, driving control signal CTRL, and the area position information PI′ to the DDI 920.

The host controller 910 may include a main processor 911, a graphic processor 912, a display controller 913, and a display interface circuit 914. The main processor 911, the graphic processor 912, and the display controller 913 may include the application processor 111 of FIG. 1.

The main processor 911 may control the overall operation of the host controller 910. The main processor 911 may generate and provide the display control signal DCTRL for controlling the display controller 913 and the image data IDAT used to generate the frame data FDAT. For example, the image data IDAT may be provided directly to the display controller 913, or may be rendered by the graphic processor 912 and provided to the display controller 913 as the rendering data RFDAT.

The graphic processor 912 may render the images displayed on the display device 120. For example, the graphic processor 912 may perform the foveated rendering based on the image data IDAT and the eye tracking data ED to generate the rendering data RFDAT and the area position information PI, and generate the rendering information RINF related to the rendering operation. For example, the rendering information RINF may include the rendering speed of the graphic processor 912. The graphic processor 912 may provide the rendering data RFDAT and the area position information PI to the display controller 913, and may provide the rendering information RINF to the main processor 911.

The display controller 913 may be controlled by the main processor 911 and may control the operation of the DDI 920. The display controller 913 may generate the driving control signal CTRL based on the display control signal DCTRL, and the frame data HFDAT and LFDAT or the combination frame data EFDAT based on the image data IDAT or the rendering data RFDAT. The driving control signal CTRL and the frame data HFDAT and LFDAT ((1)/the combination frame data EFDAT (2) may be provided to the DDI 920.

In some example embodiments, the display controller 913 may generate the first frame data HFDAT and the second frame data LFDAT based on the rendering data RFDAT.

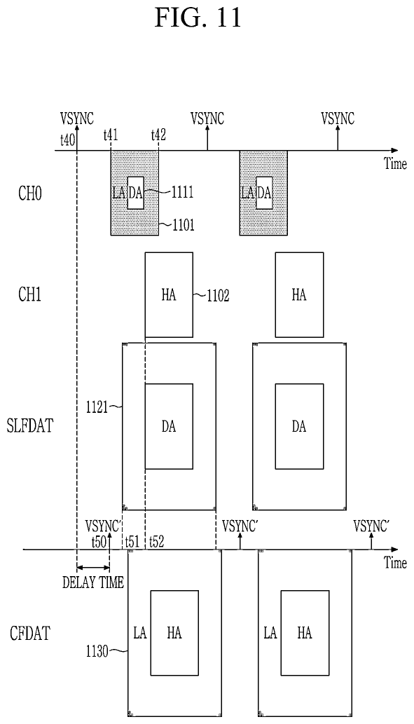

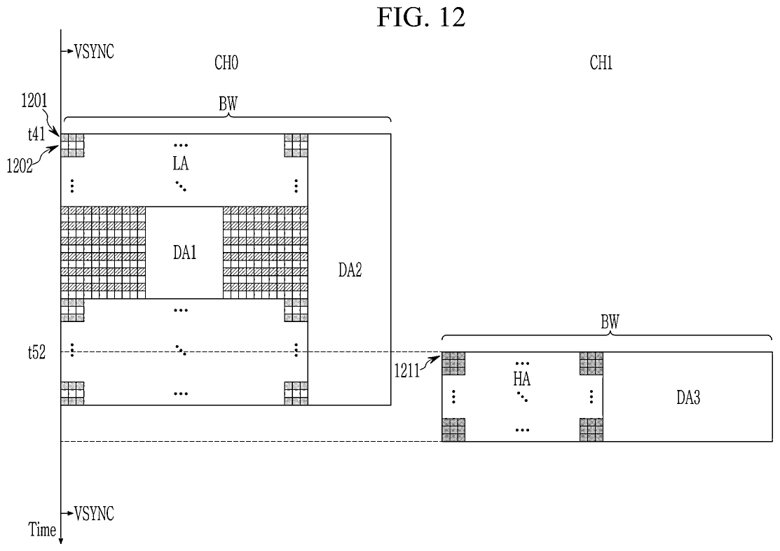

The first frame data HFDAT may include the high resolution frame data, and the second frame data LFDAT may include the low resolution frame data. The second frame data LA may include the low resolution frame data that the image (e.g., 300 in FIG. 3) is rendered with a low resolution. The display controller 913 may generate the second frame data LFDAT, which includes only the pixel data of the second area that does not overlap with the first area within the image 300, based on the area position information PI. This is described with reference to FIG. 11 and FIG. 12. The display controller 913 may output the first frame data HFDAT and the second frame data LFDAT to the display interface circuit 914. In some example embodiments, when outputting the first frame data HFDAT and the second frame data LFDAT, the display controller 913 may output some information PI′ of the area position information PI to the display interface circuit 914. For example, the area position information PI′ may include the X-axis coordinate value. The display controller 913 may determine the mixing timing of two frame data HFDAT and LFDAT based on the area position information PI, and determine the transmission timing of two frame data HFDAT and LFDAT based on the determined mixing timing. The display controller 913 may insert a dummy data between the line data of the second frame data LFDAT so that the second frame data LFDAT is transmitted or sent with a relatively low speed.

The display device 120 may display the first frame data HFDAT and the second frame data LFDAT during one frame period.

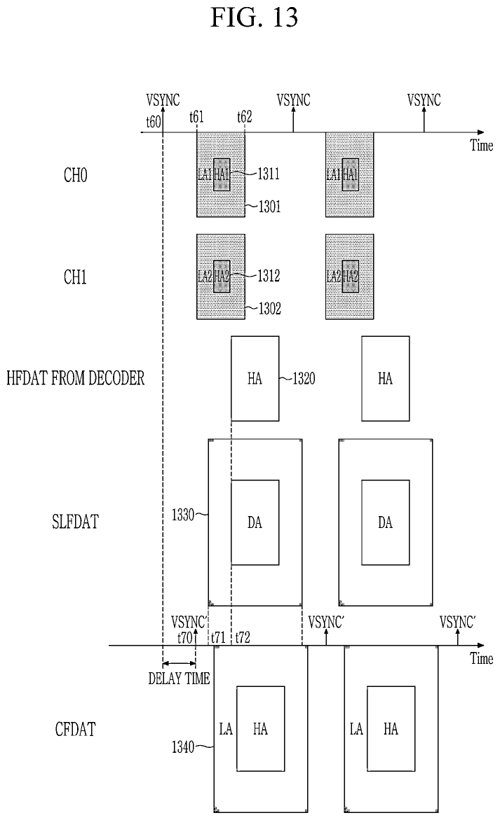

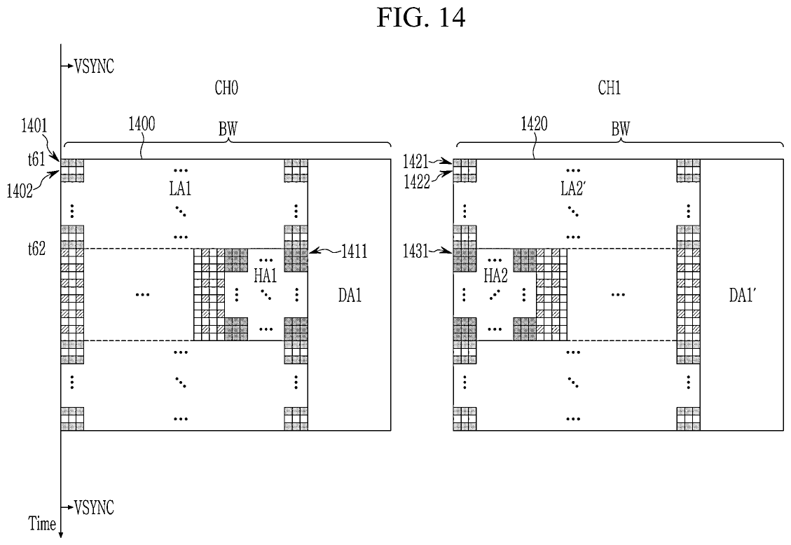

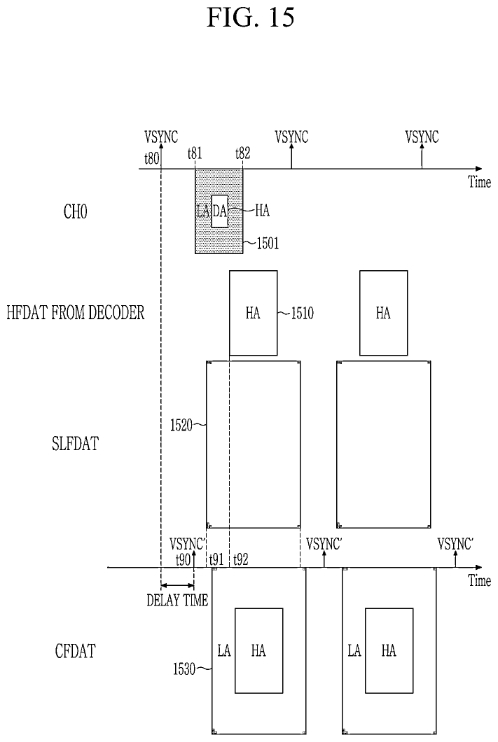

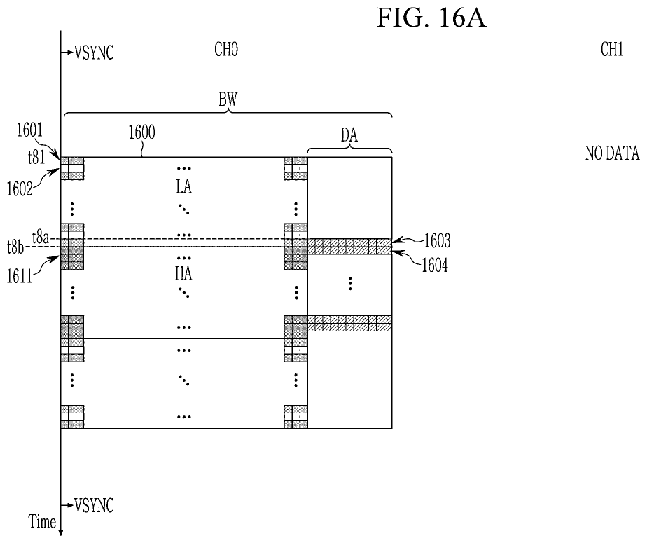

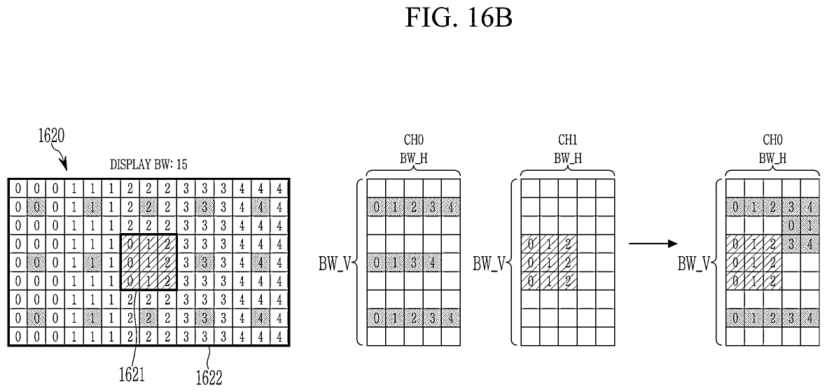

In some example embodiments, the display controller 913 may generate a plurality of combination frame data that combines the high resolution frame data and the low resolution frame data based on the rendering data RFDAT. For example, the display controller 913 may generate two combination frame data EFDAT that the high resolution frame data and the low resolution frame data are combined. This is described with reference to FIG. 13 and FIG. 14. In some example embodiments, the display controller 913 may generate one combination frame data EFDAT that the high resolution frame data and the low resolution frame data are combined based on the rendering data RFDAT. This is described with reference to FIG. 15, FIG. 16A, and FIG. 16B. The display controller 913 may generate a mapping information MI that indicates the arrangement of the high resolution frame data and the low resolution frame data within the combination frame data EFDAT. The display controller 913 may output the combination frame data EFDAT and the mapping information MI to the display interface circuit 914.

The display device 120 may display the combination frame data EFDAT during one frame period.

The display interface circuit 914 may receive the frame data HFDAT and LFDAT, the driving control signal CTRL, and the area position information PI′ from the display controller 913 and transmit or send them to the DDI 920 (in a case (1)). The display interface circuit 914 may transmit or send the first frame data HFDAT and the second frame data LFDAT through the plurality of signal channels to display the image of one frame. In some example embodiments, the second frame data LFDAT may be transmitted or sent through the first signal channel among the plurality of signal channels, and the first frame data HFDAT may be transmitted or sent through the second signal channel among the plurality of signal channels. At any point in time, according to some example embodiments, the first frame data HFDAT and the second frame data LFDAT may be transmitted or sent together, or only one of the first frame data HFDAT and the second frame data LFDAT may be transmitted or sent.

The display interface circuit 914 may receive the combination frame data EFDAT, the mapping information MI, and the driving control signal CTRL from the display controller 913 and may transmit or send them to the DDI 920 (in a case (2).

The DDI 920 may receive the frame data HFDAT and LFDAT, the driving control signal CTRL, and the area position information PI′, and display the image on the pixel array 122 based thereon. The DDI 920 may receive the combination frame data EFDAT, the mapping information MI, and the driving control signal CTRL, and display the image on the pixel array 122 based thereon. The DDI 920 may include a host interface circuit 921, an image processing circuit 922, a timing controller 928, and a driver circuit 929.

The host interface circuit 921 may receive the first frame data HFDAT and the second frame data LFDAT, the driving control signal CTRL, and the area position information PI′, and may transmit or send the first frame data HFDAT, the second frame data LFDAT, and the area position information PI′ to the image processing circuit 922 (in the case (1)). The host interface circuit 921 may transmit or send the driving control signal CTRL to the timing controller 928. The host interface circuit 921 may transmit or send a driving control signal CTRL′ in which some synchronization signals among the driving control signals CTRL are delayed to the timing controller 928. For example, the host interface circuit 921 may transmit or send the driving control signal CTRL′, which delays the vertical synchronization signal VSYNC and the horizontal synchronizing signal HSYNC of the driving control signal CTRL to the timing controller 928.

The host interface circuit 921 may receive the combination frame data EFDAT, the mapping information MI, and the driving control signal CTRL, and may transmit or send the combination frame data EFDAT and the mapping information MI to the image processing circuit 922 (in the case (2)). The host interface circuit 921 may transmit or send the driving control signal CTRL to the timing controller 928. The host interface circuit 921 may transmit or send the driving control signal CTRL′, which delays some synchronization signals among the driving control signal CTRL, to the timing controller 928.

The image processing circuit 922 may generate a synthesis frame data CFDAT based on the first frame data HFDAT, the second frame data LFDAT, and the area position information PI′, and output the synthesis frame data CFDAT to the timing controller 928 (in the case (1).

The image processing circuit 922 may generate the synthesis frame data CFDAT based on the combination frame data EFDAT and the mapping information MI, and output the synthesis frame data CFDAT to the timing controller 928 (in the case (2)).

The image processing circuit 922 may include a decoder 923, a scaler 926, and a mixer 927.

The decoder 923 may receive the combination frame data EFDAT and generate the first frame data HFDAT and the second frame data LFDAT based on the combination frame data EFDAT (in the case (2)). The decoder 923 may rearrange the first frame data HFDAT and the second frame data LFDAT from the combination frame data EFDAT based on the mapping information MI. The decoder 923 may output the first frame data HFDAT and the second frame data LFDAT to the scaler 926 and the mixer 927, respectively, in synchronization with the mixing timing of first frame data HFDAT and the second frame data LFDAT.

The scaler 926 may receive the second frame data LFDAT, up-scale the second frame data LFDAT, and output the up-scaled second frame data SLFDAT. The scaler 926 may receive the second frame data LFDAT from the host interface circuit 921 (in the case (1), or receive the second frame data LFDAT from the decoder 923 (in the case (2)).

The scaler 926 may perform the up-scaling for each line of the second frame data LFDAT. The scaler 926 may not perform the up-scaling on lines including the dummy data. For example, the scaler 926 may not perform the upscaling on the dummy data inserted between the valid line data.

The mixer 927 may receive the up-scaled second frame data SLFDAT from the scaler 926 and the first frame data HFDAT from the host interface circuit 921 (in the case (1) The mixer 927 may receive the up-scaled second frame data SLFDAT from the scaler 926 and the first frame data HFDAT from the decoder 923 (in the case (2)). The receiving timing of the first frame data HFDAT may be substantially the same as the mixing timing of the first frame data HFDAT and the up-scaled second frame data SLFDAT. In some example embodiments, the mixer 927 may mix the first frame data HFDAT and the up-scaled second frame data SLFDAT received in synchronization with the timing of receiving the up-scaled second frame data SLFDAT from the scaler 926. In some example embodiments, the mixer 927 may include a line buffer (not shown). The mixer 927 may mix the up-scaled second frame data SLFDAT and the first frame data HFDAT based on the area position information PI′. For example, the mixer 927 may synthesize the first frame data HFDAT to the second frame data SLFDAT based on the X-axis coordinate value of the area position information PI′. The mixer 927 may output the synthesis frame data CFDAT to the timing controller 928.

The timing controller 928 may generate the data signal DATA and the control signal CONT based on the synthesis frame data CFDAT and the driving control signal CTRL′.

The driver circuit 929 may generate a plurality of data voltages and a plurality of scan signals provided to the pixel array 122 based on the data signal DATA and the control signal CONT. The pixel array 122 may display the foveated image based on the synthesis frame data CFDAT based on the plurality of data voltages and the plurality of scan signals.

Compared with the display system 200 of FIG. 2, according to some example embodiments, since the display system 900 of FIG. 9 does not include the frame buffer 223, the area overhead may be reduced, and the power consumption for driving the frame buffer 223 may be prevented or reduced. In some example embodiments, since the host controller 910 transmits two frame data HFDAT and LFDAT in consideration of the mixing timing of two frame data HFDAT and LFDAT, the display system 900 of FIG. 9 may reduce a video latency by the frame buffer 223 input/output. Further, in some example embodiments, since the combination data is transmitted or sent using one signal channel, the display system 900 of FIG. 9 may prevent the power consumption due to the data transmitting/receiving.

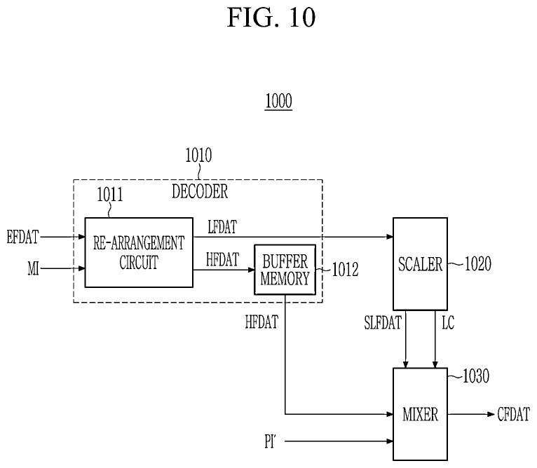

FIG. 10 is a block diagram showing a part of a display driving circuit according to some example embodiments.

Referring to FIG. 10, the DDI 1000 may include a decoder 1010, a scaler 1020, and a mixer 1030. The description of the scaler 1020 and the mixer 1030 is the same or similar to the description of the scaler 926 and the mixer 927 in FIG. 9 so that the description is omitted.

The decoder 1010 may receive the combination frame data EFDAT and the mapping information MI and generate the first frame data HFDAT and the second frame data LFDAT. The decoder 1010 may include a re-arrangement circuit 1011 and a buffer memory 1012.

The re-arrangement circuit 1011 may determine the first frame data HFDAT and the second frame data LFDAT in the combination frame data EFDAT based on the mapping information MI, and extract the first frame data HFDAT and the second frame data LFDAT from the combination frame data EFDAT. The mapping information MI may include information about the positions of the first frame data HFDAT and the second frame data LFDAT within the combination frame data EFDAT.

The buffer memory 1012 may temporarily store the first frame data HFDAT. The buffer memory 1012, which stores the first frame data HFDAT, may have a smaller size than frame buffer 223, which stores the second frame data LFDAT. The buffer memory 1012 may provide the first frame data HFDAT to the mixer 1030 in synchronization with the mixing timing of the mixer 1030. In some example embodiments, the buffer memory 1012 may output the first frame data HFDAT at a timing determined based on the delay according to the scaling of the mapping information MI and the scaler 1020.

FIG. 11 is a timing diagram showing timings related to a frame data in a display system according to some example embodiments.

Referring to FIG. 9 and FIG. 11 together, the vertical synchronization signal VSYNC may be input at a time t40. The host interface circuit 921 may output the vertical synchronization signal VSYNC′, which the vertical synchronization signal VSYNC is delayed from a time t40 to a time t50 by the delay time DELAY TIME.

Through the first signal channel CH0, the second frame data 1101 may be input at a time t41. At a time t42, the input of second frame data 1101 may be completed. The second frame data 1101 may only include the pixel data of the second area that does not overlap the first area within the image 300. For example, the second frame data 1101 may include dummy data 1111 corresponding to an area that overlaps the first area.

The scaler 926 may receive the second frame data 1101 and up-scale the second frame data 1101. The scaler 926 may output the up-scaled second frame data 1121 at a time t51. The scaler 926 may up-scale the second frame data 1101 by 2 times in the horizontal direction H and 2 times in the vertical direction Y. In synchronization with the mixing timing of the up-scaled second frame data 1121 and the first frame data 1102, the first frame data 1102 may be input through the second signal channel CH1 at a time t52.

The mixer 927 may mix the up-scaled second frame data 1121 and the first frame data 1102 based on the area position information PI. The mixer 927 may output the synthesis frame data 1130 in which the up-scaled second frame data 1121 and the first frame data 1102 are mixed.

FIG. 12 is a view showing an example of a frame data in a display system according to some example embodiments.

Referring to FIG. 9 and FIG. 12, the second frame data LA may be input to the host interface circuit 921 through the first signal channel CH0, and the first frame data HA may be input to the host interface circuit 921 through the second signal channel CH1.

At a time t41, the first line data 1201 of the second frame data LA may be input. The second frame data LA may only include the pixel data from the second area that does not overlap the first area within the image 300. For example, the second frame data LA may include the dummy data DA1 corresponding to the area that overlaps the first area. The second frame data LA may have a size less than the bandwidth BW of the first signal channel CH0. Therefore, the second frame data LA and the dummy data DA2 can be transmitted or sent through the first signal channel CH0.

In FIG. 12, it is assumed that the first frame data HA is rendered with 4× quality, and the second frame data LA is rendered with 1× quality. For example, the second frame data LA may be a data rendered so that a 3840×2160 resolution image is displayed as a 1920×1080 resolution image. The first line data 1201 of the second frame data LA may include the 1920 pixel data in which the first line data including the 3840 pixel data and the second line data including the 3840 pixel data are reduced by ¼, and the second line data 1202 may include a dummy data. Accordingly, in some example embodiments, compared to the second frame data LA of FIG. 5, the second frame data LA may be transmitted or sent relatively slowly.

At a time t52, the first line data 1211 of the first frame data HA may be input. Depending on the size of the first area 310 in the image (300 in FIG. 3), the first line data 1211 of the first frame data HA may include the plurality of pixel data. The first frame data HA may also have a size less than the bandwidth BW of the second signal channel CH1. Therefore, the first frame data HA and the dummy data DA3 may be transmitted or sent through the second signal channel CH1.

FIG. 13 is a timing diagram showing timings related to a frame data in a display system according to some example embodiments.

Referring to FIG. 9 and FIG. 13 together, the vertical synchronization signal VSYNC may be input at a time t60. The host interface circuit 921 may output the vertical synchronization signal VSYNC′, which the vertical synchronization signal VSYNC is delayed from the time t60 to the time t70 by the delay time DELAY TIME.

At a time t61, the first combination frame data 1301 may be input through the first signal channel CH0, and the second combination frame data 1302 may be input through the second signal channel CH1. In some example embodiments, the first combination frame data 1301 and the second combination frame data 1302 may be received simultaneously. At a time t62, the input of the first combination frame data 1301 may be completed. The first combination frame data 1301 may include a part LA1 of the low resolution frame data and a part HA1 of the high resolution frame data, and the second combination frame data 1302 may include another part LA2 of the low resolution frame data and another part HA2 of the high resolution frame data.

The decoder 923 may generate the second frame data from the first combination frame data 1301 and the second combination frame data 1302, and output the second frame data to the scaler 926. The decoder 923 may generate the first frame data 1320 from first combination frame data 1301 and the second combination frame data 1302.

The scaler 926 may receive the second frame data and up-scale the second frame data. The scaler 926 may output the up-scaled second frame data 1330 at a time t71. The scaler 926 may up-scale the second frame data by 2 times in the horizontal direction H and 2 times in the vertical direction Y. In synchronization with the mixing timing of the up-scaled second frame data 1330 and the first frame data 1320, the first frame data 1320 may be input from the decoder 923 at a time t52.

The mixer 927 may mix the up-scaled second frame data 1330 and the first frame data 1320 based on the area position information PI. The mixer 927 may output the synthesis frame data 1340 by mixing the up-scaled second frame data 1330 and the first frame data 1320.

FIG. 14 is a view showing an example of a frame data in a display system according to some example embodiments.

Referring to FIG. 9 and FIG. 14, the first combination frame data 1400 may be input to the host interface circuit 921 through the first signal channel CH0, and the second frame data 1420 may be input to the host interface circuit 921 through the second signal channel CH1.

The first combination frame data 1400 may include a part of the high resolution frame data HA1 that displays the first area (e.g., 310 in FIG. 3) within the image (e.g., 300 in FIG. 3) and a part LA1 of the low resolution frame data representing the second area (e.g., 320 in FIG. 3) within the image 300 (e.g., 300 in FIG. 3). The part LA1 of the low resolution frame data may include some pixel data of the second area 320 that does not overlap the first area 310 within the image 300. For example, the part LA1 of the low resolution frame data may not include the pixel data corresponding to the area that overlaps the first area 310 among the data of the second area 320.

At a time t61, the first line data 1401 of the first combination frame data 1400 and the first line data 1421 of the second combination frame data 1420 may be input. The first combination frame data 1400 may have a size less than the bandwidth BW of the first signal channel CH0. Therefore, in some example embodiments, the first combination frame data 1400 and the dummy data DA1 may be transmitted or sent through the first signal channel CH0. The second combination frame data 1420 may have a size less than the bandwidth BW of the second signal channel CH1. Therefore, in some example embodiments, the second combination frame data 1420 and the dummy data DA1′ may be transmitted or sent through the second signal channel CH1.

In FIG. 14, it is assumed that the high resolution frame data HA1 and HA2 are rendered with 4× quality, and the low resolution frame data LA1 and LA2 are rendered with 1X quality. For example, the low resolution frame data LA1 and LA2 may be data rendered so that a 3840×2160 resolution image is displayed as a 1920×1080 resolution image. The first line data 1401 and 1421 of the low resolution frame data LA1 and LA2 may include the 1920 pixel data in which the first line data including the 3840 pixel data and the second line data including the 3840 pixel data are reduced by ¼, and the second line data 1402 and 1422 may include a dummy data. Accordingly, in some example embodiments, compared to the second frame data LA of FIG. 5, the low resolution frame data LA1 and LA2 may be transmitted or sent relatively slowly.

At a time t62, the first line data 1411 of the high resolution frame data HA1 of the first combination frame data 1400 and the first line data 1431 of the high resolution frame data HA2 of the second combination frame data 1420 may be input. Since the first combination frame data 1400 and the second combination frame data 1420 do not include the pixel data corresponding to the area that overlaps the first area 310 among the data of the second area 320, but include the high resolution frame data HA1 and HA2, the first combination frame data 1400 and the second combination frame data 1420 input at a time t62 may have a size less than the bandwidth BW of the second signal channel CH1.

FIG. 15 is a timing diagram showing timings related to a frame data in a display system according to some example embodiments.

Referring to FIG. 9 and FIG. 15 together, the vertical synchronization signal VSYNC may be input at a time t80. The host interface circuit 921 may output the vertical synchronization signal VSYNC′, which the vertical synchronization signal VSYNC is delayed from a time t80 to a time t90 by the delay time DELAY TIME.

At a time t91, the combination frame data 1501 may be input through the first signal channel CH0. When one combination frame data 1501 is transmitted or sent, data is not input through the second signal channel CH1. The combination frame data 1501 may include the low resolution frame data LA and the high resolution frame data HA.

The decoder 923 may generate the second frame data from the combination frame data 1501 and output the second frame data to the scaler 926. The decoder 923 may generate the first frame data 1510 from the combination frame data 1501.

The scaler 926 may receive the second frame data and up-scale the second frame data. The scaler 926 may output the up-scaled second frame data 1520 at a time t91. The scaler 926 may up-scale the second frame data by 2 times in the horizontal direction H and 2 times in the vertical direction Y. In synchronization with the mixing timing of the up-scaled second frame data 1520 and the first frame data 1510, the first frame data 1520 may be input from the decoder 923 at a time t92.

The mixer 927 may mix the up-scaled second frame data 1520 and the first frame data 1510 based on the area position information PI. The mixer 927 may output the synthesis frame data 1530 by mixing the up-scaled second frame data 1520 and the first frame data 1510.

FIG. 16A is a view showing an example of a frame data in a display system according to some example embodiments.

Referring to FIG. 9 and FIG. 16A, one combination frame data 1600 may be input to the host interface circuit 921 through the first signal channel CH0.

The combination frame data 1600 may include the high resolution frame data HA, which displays the first area (e.g., 310 in FIG. 3) within the image (e.g., 300 in FIG. 3), and the low resolution frame data LA, which displays the second area (e.g., 320 in FIG. 3) within the image 300. The low resolution frame data LA may include the pixel data of the second area 320 that does not overlap the first area 310 within the image 300. For example, the low resolution frame data LA may not include the pixel data corresponding to the area that overlaps the first area 310 among the data of the second area 320.

At a time t81, the first line data 1601 of the combination frame data 1600 may be input. At a time t82, the input of the combination frame data 1600 may be completed. The first line data 1601 of the combination frame data 1600 may have a size less than the bandwidth BW of the first signal channel CH0. Therefore, in some example embodiments, the combination frame data 1600 and the dummy data DA may be transmitted or sent through the first signal channel CH0.

In FIG. 16A, it is assumed that the high resolution frame data HA is rendered with 4× quality, and the low resolution frame data LA is rendered with 1× quality. For example, the low resolution frame data LA may be a data rendered so that a 3840×2160 resolution image is displayed as a 1920×1080 resolution image. The first line data 1601 of the low resolution frame data LA may include the 1920 pixel data in which the first line data including the 3840 pixel data and the second line data including the 3840 pixel data are reduced by ¼, and the second line data 1602 may include dummy data.

Accordingly, in some example embodiments, compared to the second frame data LA of FIG. 5, the low resolution frame data LA may be transmitted or sent relatively slowly.

At a time t8a and a time t8b, the first line data 1603 and 1604 of some of the low resolution frame data LA may be input. At a time t8b, the first line data 1611 of the high resolution frame data HA may be input. The first line data 1603 and 1604 may include the pixel data (e.g., a part of the low resolution frame data LA) of the area displayed at substantially the same timing as the first area 310 of the second area 320. For example, the first line data 1611 and the first line data 1603 and 1604 of the high resolution frame data HA for displaying the first area 310 may be displayed at substantially the same timing. Therefore, in some example embodiments, the input of the first line data 1611, and the first line data 1603 and 1604 may be completed at substantially the same time. A part of the low resolution frame data LA may include a data for displaying an area adjacent to the first area 310 of the second area 320 in the horizontal direction within the image 300.

The display controller 913 may generate the combination frame data for the transmission through one signal channel if Equation 1 below is satisfied.

$$C {H}_{Hr} + ( 1 - {DP}_{Hr} ) \times C {H}_{L R} \times {CH}_{L V R} \leq 0.5 \qquad ( Equation 1 )$$

Here, CH_{Hr} may be a ratio of one line data of the high resolution frame data and a bandwidth of the entire signal channels CH0 and CH1, DP_{Hr} is a ratio of a pixel displayed by the high resolution frame data among one line of the image displayed on the pixel array 122, CH_{Lr} is a horizontal direction ratio of one line data of the low resolution frame data and the bandwidth of the entire signal channels CH0 and CH1, and CH_{LVR} is a vertical direction ratio of one line data of the low resolution frame data and the bandwidth of the entire signal channels CH0 and CH1.

For example, referring to FIG. 16B, in some example embodiments, one line of one frame data 1620 may include 15 pixel data, and one line data of high resolution frame data 1621 may be 3 pixel data. The horizontal direction bandwidth BW_H of the entire signal channels CH0 and CH1 is 10, the vertical direction bandwidth BW_V is 9, the low resolution frame data is down-scaled by ⅓ times in the horizontal direction and ⅓ times in the vertical direction, since CH_{Lr} is 3/10, DP_{Hr} is 3/15, CH_{Lr} is 4/10, CH_{LVR} is ⅓, the left side of Equation 1 is calculated as 0.40666 . . . that is less than 0.5, thereby the combination frame data may be transmitted or sent through one channel CH0.

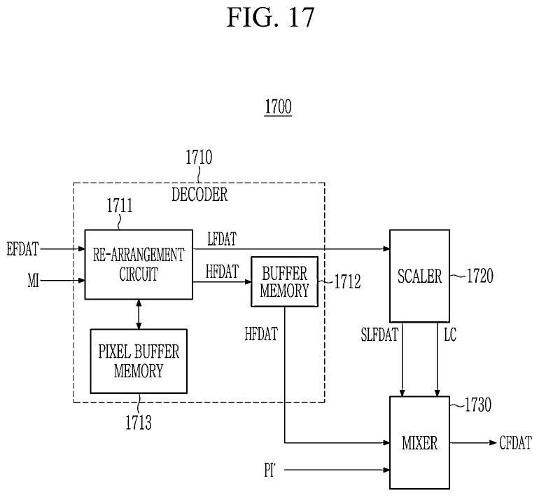

FIG. 17 is a block diagram showing a part of a display driving circuit according to some example embodiments.

Referring to FIG. 17, a DDI 1700 may include a decoder 1710, a scaler 1720, and a mixer 1730. The description of the scaler 1720 and the mixer 1730 is the same or similar to the description of the scaler 926 and the mixer 927 in FIG. 9, the description thereof is omitted.

The decoder 1710 may receive the combination frame data EFDAT and the mapping information MI and generate the first frame data HFDAT and the second frame data LFDAT. The decoder 1710 may include a re-arrangement circuit 1711, a buffer memory 1712, and a pixel buffer memory 1713.

The re-arrangement circuit 1711 may determine the first frame data HFDAT and the second frame data LFDAT within the combination frame data EFDAT based on the mapping information MI, and extract the first frame data HFDAT and the second frame data LFDAT from the combination frame data EFDAT. The mapping information MI may include the information about the positions of the first frame data HFDAT and the second frame data LFDAT within the combination frame data EFDAT. The re-arrangement circuit 1711 may temporarily store a part of the second frame data LFDAT in the pixel buffer memory 1713.

The re-arrangement circuit 1711 may store a portion of the second frame data LFDAT in the pixel buffer memory 1713, where the order of the arrangement within the combination frame data EFDAT and the order of the display on the pixel array 122 are different. Within the combination frame data EFDAT, the second frame data LFDAT may not be arranged according to the displayed order. For example, through the signal channel, the pixel data displayed after the first timing may be input before the pixel data displayed at the first timing is input. At this time, the pixel data displayed after the first timing may include the pixel data of the area displayed at substantially the same timing as the first area among the second area. The re-arrangement circuit 1711 may temporarily store the pixel data displayed after the first timing in the pixel buffer memory 1713. When the pixel data displayed at the first timing is input, the re-arrangement circuit 1711 may output the pixel data displayed at the first timing to the scaler 1720, read the pixel data displayed after the first timing to the pixel buffer memory 1713, and read the pixel data displayed after the first timing, and output the pixel data displayed after the first timing to the scaler 1720.

The buffer memory 1712 may temporarily store the first frame data HFDAT. The buffer memory 1712 that stores the first frame data HFDAT may have a smaller size than the frame buffer (e.g., 223 in FIG. 2) that stores the second frame data LFDAT. The buffer memory 1712 may provide the first frame data HFDAT to the mixer 1730 in synchronization with the mixing timing of the mixer 1730. In some example embodiments, the buffer memory 1712 may output first frame data HFDAT at a timing determined based on the delay according to the mapping information MI and the scaling of the scaler 1720.

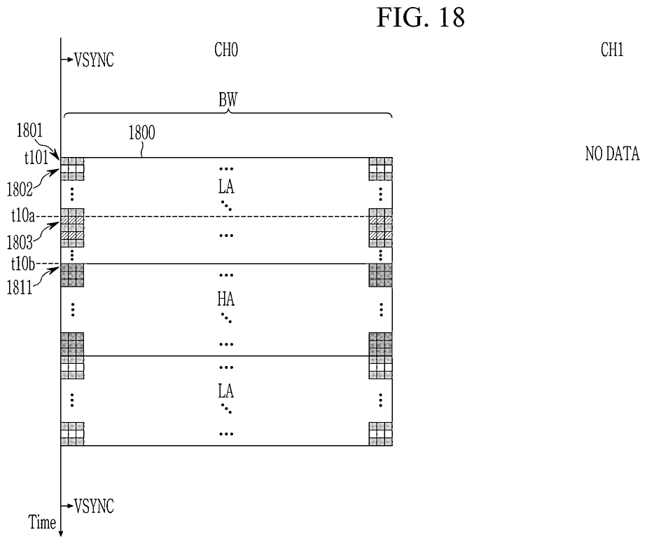

FIG. 18 is a view showing an example of a frame data in a display system according to some example embodiments.

Referring to FIG. 9 and FIG. 18, one combination frame data 1800 may be input to the host interface circuit 921 through the first signal channel CH0.

The combination frame data 1800 may include the high resolution frame data HA, which displays the first area (e.g., 310 in FIG. 3) within the image (e.g., 300 in FIG. 3), and the low resolution frame data LA, which displays the second area (e.g., 320 in FIG. 3) within the image 300. The low resolution frame data LA may include the pixel data of the second area 320 that does not overlap the first area 310 within the image 300. For example, the low resolution frame data LA may not include the pixel data corresponding to the area that overlaps the first area 310 among the data of the second area 320.

At a time t101, the first line data 1801 of the combination frame data 1800 may be input. The first line data 1801 of the combination frame data 1800 may have a size less than the bandwidth BW of the first signal channel CH0.

In FIG. 18, it is assumed that the high resolution frame data HA is rendered with 4× quality, and the low resolution frame data LA is rendered with 1× quality. For example, the low resolution frame data LA may be a data rendered so that a 3840×2160 resolution image is displayed as a 1920×1080 resolution image. The first line data 1801 of the low resolution frame data LA may include the 1920 pixel data in which the first line data including the 3840 pixel data and the second line data including the 3840 pixel data are reduced by ¼, and the second line data 1802 may include a dummy data. Hereby, according to some example embodiments, compared to the second frame data LA of FIG. 5, the low resolution frame data LA may be transmitted or sent relatively slowly.

At a time t10a, the pixel data 1803 of a part of the low resolution frame data LA may be input. The pixel data 1803 may include pixel data of the area displayed at substantially the same timing as the first area 310 of the second area 320. For example, a part of the first line data 1811 and the pixel data 1803 of the high resolution frame data HA for displaying the first area 310 may be displayed at substantially the same timing. In some example embodiments, a part of the low resolution frame data LA may include a data for displaying an area adjacent to the first area 310 of the second area 320 in the horizontal direction within the image 300.

At a time t10b, the first line data 1811 of the high resolution frame data HA may be input. For example, the first line data 1811 of the high resolution frame data HA for displaying the first area 310 and the pixel data 1803 of a part of the low resolution frame data LA may be displayed at substantially the same timing.

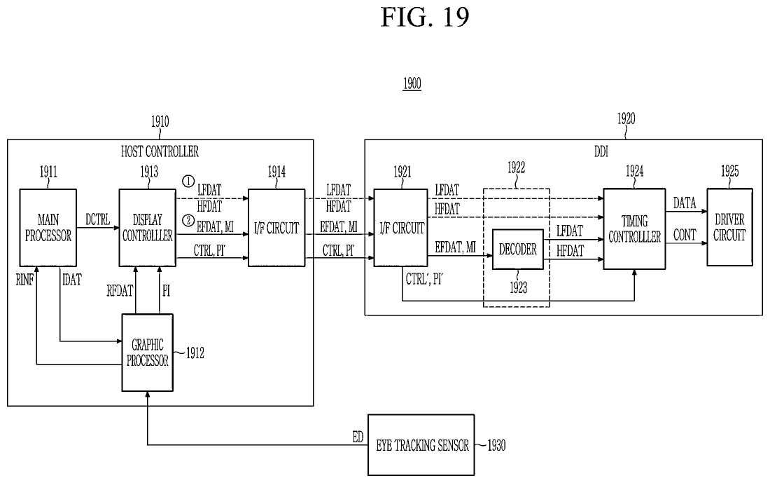

FIG. 19 is a block diagram showing a part of a display system according to some example embodiments.

Referring to FIG. 19, a display system 1900 may include a host controller 1910, a DDI 1920, and an eye tracking sensor 1930. Among the components of FIG. 19, description of the components that are the same or similar to those in FIG. 2, FIG. 6, and FIG. 99 is omitted.

The host controller 1910 may receive the eye tracking data ED from the eye tracking sensor 1930, generate the first frame data HFDAT and the second frame data LFDAT, the driving control signal CTRL, and the area position information PI based on the eye tracking data ED, and transmit or send the first and second frame data HFDAT and LFDAT/the combination frame data EFDAT, and the driving control signal CTRL, and the area position information PI to the DDI 1920. The host controller 1910 may include a main processor 1911, a graphic processor 1912, a display controller 1913, and a display interface circuit 1914. The description of the host controller 1910 is the same as or similar to the description of the host controller 910 of FIG. 10 so that the description thereof is omitted.

The DDI 1920 may receive the frame data HFDAT and LFDAT, the driving control signal CTRL, and the area position information PI′, and display the image of the pixel array (e.g., 122 of FIG. 1) based thereon. The DDI 1920 may receive the combination frame data EFDAT, the mapping information MI, and the driving control signal CTRL, and display the image on the pixel array 122 based thereon. The DDI 1920 may include a host interface circuit 1921, an image processing circuit 1922, a timing controller 1924, and a driver circuit 1925.

The host interface circuit 1921 may receive the first frame data HFDAT and the second frame data LFDAT, the driving control signal CTRL, and the area position information PI′, and transmit or send the first frame data HFDAT, the second frame data LFDAT, and the area position information PI′ to the image processing circuit 1922 (in the case (1). The host interface circuit 1921 may transmit or send the driving control signal CTRL to the timing controller 1924. The host interface circuit 1921 may transmit or send the driving control signal CTRL′, in which some synchronization signals among the driving control signals CTRL are delayed, to the timing controller 1924. For example, the host interface circuit 1921 may transmit or send the driving control signal CTRL′, which the vertical synchronization signal VSYNC and the horizontal synchronizing signal HSYNC among the driving control signal CTRL are delayed, to the timing controller 1924.

The host interface circuit 1921 may receive the combination frame data EFDAT, the mapping information MI, the driving control signal CTRL, and the area position information PI′, transmit or send the combination frame data EFDAT and the mapping information MI to the image processing circuit 1922, and transmit or send the area position information PI′ to the timing controller 1924 (the case (2)). The host interface circuit 1921 may transmit or send the driving control signal CTRL to the timing controller 1924. The host interface circuit 1921 may transmit or send the driving control signal CTRL′, in which some synchronization signals among the driving control signals CTRL are delayed, to the timing controller 1924.

The image processing circuit 1922 may output the first frame data HFDAT and the second frame data LFDAT to the timing controller 1924 (in the case of (1).

The image processing circuit 1922 may generate the first frame data HFDAT and the second frame data LFDAT based on the combination frame data EFDAT and the mapping information MI, and output the first frame data HFDAT and the second frame data LFDAT to the timing controller 1924 (in the case (2)).

The image processing circuit 1922 may include a decoder 1923.

The decoder 1923 may receive the combination frame data EFDAT and generate the first frame data HFDAT and the second frame data LFDAT based on the combination frame data EFDAT (in the case (2)). The decoder 1923 may rearrange the first frame data HFDAT and the second frame data LFDAT from the combination frame data EFDAT based on mapping information MI. The decoder 1923 may output the first frame data HFDAT and the second frame data LFDAT to the timing controller 1924 in synchronization with the timing at which the first frame data HFDAT and the second frame data LFDAT are displayed on the pixel array 121.

The timing controller 1924 may generate the data signal DATA and the control signal CONT based on the first frame data HFDAT, the second frame data LFDAT, and the driving control signal CTRL′.

In some example embodiments, the timing controller 1924 may generate the data signal DATA and the control signal CONT based on the first frame data HFDAT, the second frame data LFDAT, and the area position information PI′. The timing controller 1924 may generate the data signal DATA by placing the first frame data HFDAT and the second frame data LFDAT with reference to the area position information PI. The timing controller 1924 may refer to the area position information PI′ to generate the control signal CONT that operates the driver circuit 1925 with the multi gate line driving method. For example, the timing controller 1924 may determine the second area within the image (e.g., 300 in FIG. 3) by referring to the area position information PI′. The timing controller 1924 may determine the gate line and the data line included in the second area. The timing controller 1924 may generate the control signal CONT that controls the driver circuit 1925 to provide the gate signals to the determined gate lines so that the horizontal periods of the gate signals overlap each other. The timing controller 1924 may generate the control signal CONT that controls the driver circuit 1925 to provide the same data voltage to the adjacent data lines among the determined data lines.

The driver circuit 1925 may generate the plurality of data voltages and the plurality of scan signals provided to the pixel array 122 based on the data signal DATA and the control signal CONT. The pixel array 122 may display the foveated image based on the first frame data HFDAT and the second frame data LFDAT based on the plurality of data voltages and the plurality of scan signals.

Compared with the display system 200 of FIG. 2, in some example embodiments, since the display system 1900 of FIG. 19 does not includes the frame buffer 223, the area overhead may be reduced and the power consumption for driving the frame buffer 223 may be prevented. In some example embodiments, since the host controller 1910 transmits two frame data HFDAT and LFDAT in consideration of the mixing timing of two frame data HFDAT and LFDAT, the display system 1900 of FIG. 19 may reduce a video latency due to the frame buffer 223 input/output. Further, in some example embodiments, since the combination data is transmitted or sent using one signal channel, the display system 1900 of FIG. 19 may prevent the power consumption due to the data transmitting/receiving.

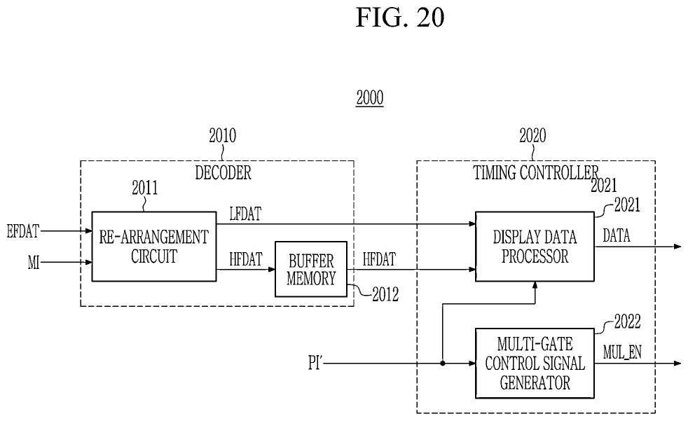

FIG. 20 is a block diagram showing a part of a display driving circuit according to some example embodiments.

Referring to FIG. 20, a DDI 2000 may include a decoder 2010 and a timing controller 2020.

The decoder 2010 may receive the combination frame data EFDAT and the mapping information MI and generate the first frame data HFDAT and the second frame data LFDAT. The decoder 2010 may include a re-arrangement circuit 2011 and a buffer memory 2012.

The re-arrangement circuit 2011 may determine the first frame data HFDAT and the second frame data LFDAT within the combination frame data EFDAT based on the mapping information MI, and extract the first frame data HFDAT and the second frame data LFDAT from the combination frame data EFDAT. The mapping information MI may include an information about the positions of the first frame data HFDAT and the second frame data LFDAT within the combination frame data EFDAT.

The buffer memory 2012 may temporarily store the first frame data HFDAT. The buffer memory 2012, which stores the first frame data HFDAT, may have a smaller size than the frame buffer 223, which stores the second frame data LFDAT. The buffer memory 2012 may provide the first frame data HFDAT to the mixer 2030 in synchronization with the mixing timing of mixer 2030. In some example embodiments, the buffer memory 2012 may output the first frame data HFDAT at a timing determined based on the mapping information MI and the delay according to the scaling of the scaler 2020.

The timing controller 2020 may receive the first frame data HFDAT, the second frame data LFDAT, and the area position information PI′, and output the data signal DATA and the multi gate control signal MUL_EN. The multi gate control signal MUL_EN may be included in the control signal CONT of FIG. 19. The timing controller 2020 may output a multi gate control signal MUL_EN that controls the first frame data HFDAT and the second frame data LFDAT to be displayed by different driving methods, based on the area position information PI′. For example, the timing controller 1924 may generate the multi gate control signal MUL_EN that controls to provide the gate signals to the gate lines connected to the pixels displaying the second frame data LFDAT so that the horizontal periods of the gate signals overlap each other. The timing controller 1924 may generate the multi gate control signal MUL_EN that controls to provide the same data voltage to the adjacent data lines among the data lines connected to the pixels displaying the second frame data LFDAT.

The timing controller 2020 may include a display data processor 2021 and a multi gate control signal generator 2022. The timing controller 2020 may include a display data processor 2021 and a multi gate control signal generator 2022.

The display data processor 2021 may receive the first frame data HFDAT, the second frame data LFDAT, and the area position information PI′, and generate the data signal DATA based on the first frame data HFDAT and the second frame data LFDAT. The display data processor 2021 may output the pixel data of the first frame data HFDAT or the pixel data of the second frame data LFDAT as the data signal DATA with reference to the area position information PI′. For example, the display data processor 2021 may output the pixel data of the second frame data LFDAT with reference to the area position information PI′ when outputting the data signal DATA for displaying the second area.

The multi gate control signal generator 2022 may generate the multi gate control signal MUL_EN based on the area position information PI′. The multi gate control signal generator 2022 may generate the multi gate control signal MUL_EN that controls to operate with the multi gate line driving method based on area position information PI′. For example, the multi gate control signal generator 2022 may determine a period that the data signal DATA corresponding to the second area is output based on the area position information PI′, and generate the multi gate control signal MUL_EN of controlling the driver circuit 1925 to simultaneously provide the gate signals to the plurality of gate lines included in the second area with the determined period. The multi gate control signal generator 2022 may determine a period in which the data signal DATA corresponding to the second area is output based on area position information PI′, and generate the multi gate control signal MUL_EN of controlling the driver circuit 1925 to provide the data voltage based on one pixel data to the plurality of data lines included in the second area within the determined period.

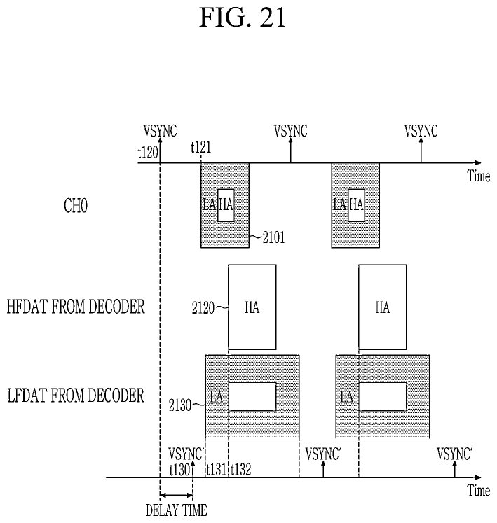

FIG. 21 is a timing diagram showing timings related to a frame data in a display system according to some example embodiments.

Referring to FIG. 19 and FIG. 21 together, the vertical synchronization signal VSYNC may be input at a time t120. The host interface circuit 1921 may output a vertical synchronization signal VSYNC′ that the vertical synchronization signal VSYNC is delayed from a time t120 to a time t130 by the delay time DELAY TIME.

At a time t121, a combination frame data 2101 may be input through the first signal channel CH0. When one combination frame data 2101 is transmitted or sent, a data is not input through the second signal channel CH1. The combination frame data 2101 may include the low resolution frame data LA and the high resolution frame data HA.

The decoder 1923 may generate a first frame data 2120 and a second frame data 2130 from the combination frame data 2101. The decoder 1923 may extract the first frame data 2120 and the second frame data 2130 from the combination frame data 2101 based on the mapping information MI. The decoder 1923 may determine the output timing of the first frame data 2120 and the second frame data 2130 based on the mapping information MI. For example, the decoder 1923 may output the second frame data 2130 at a time t131 and the first frame data 2120 at a time t132.

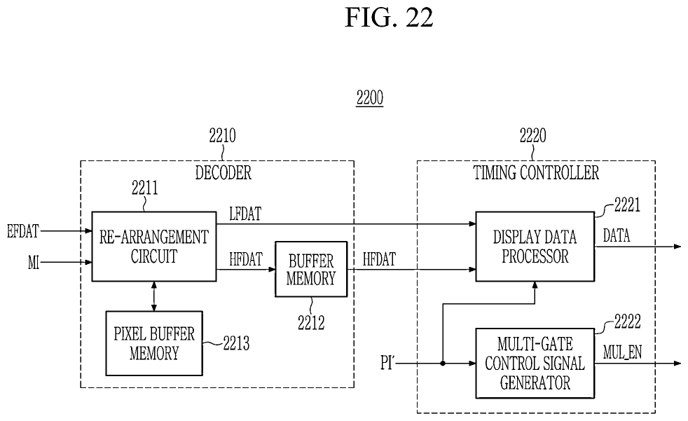

FIG. 22 is a block diagram showing a part of a display driving circuit according to some example embodiments.

Referring to FIG. 22, a DDI 2200 may include a decoder 2210 and a timing controller 2220. The description for the timing controller 2220 is the same as or similar to the description of the timing controller 2220 of FIG. 20 so that it is omitted.

The decoder 2210 may receive the combination frame data EFDAT and the mapping information MI and generate the first frame data HFDAT and the second frame data LFDAT. The decoder 2210 may include a re-arrangement circuit 2211, a buffer memory 2212, and a pixel buffer memory 2213.

The re-arrangement circuit 2211 may determine the first frame data HFDAT and the second frame data LFDAT within the combination frame data EFDAT based on the mapping information MI, and extract the first frame data HFDAT and the second frame data LFDAT from the combination frame data EFDAT. The mapping information MI may include an information about the positions of the first frame data HFDAT and the second frame data LFDAT within the combination frame data EFDAT. The re-arrangement circuit 2211 may temporarily store a part of the second frame data LFDAT in the pixel buffer memory 2213. Within the combination frame data EFDAT, the second frame data LFDAT may not be arranged according to the display order. For example, through a signal channel, the pixel data displayed after the first timing may be input before the pixel data displayed at the first timing is input. At this time, the pixel data displayed after the first timing may include the pixel data of the area displayed at substantially the same timing as the first area among the second areas. The re-arrangement circuit 2211 may temporarily store the pixel data displayed after the first timing in the pixel buffer memory 2213. The re-arrangement circuit 2211, if the pixel data displayed at the first timing is input, may output the pixel data displayed at the first timing to the timing controller 2220, read the pixel data displayed after the first timing to the pixel buffer memory 2213, and output the pixel data displayed after the first timing to the timing controller 2220.

The buffer memory 2212 may temporarily store the first frame data HFDAT. The buffer memory 2212 that stores the first frame data HFDAT may have a smaller size than the frame buffer (e.g., 223 in FIG. 2) that stores the second frame data LFDAT. The buffer memory 2212 may provide the first frame data HFDAT to the timing controller 2220 in synchronization with the timing indicating the first frame data HFDAT. In some example embodiments, the buffer memory 2212 may output the first frame data HFDAT at a timing determined based on mapping information MI.

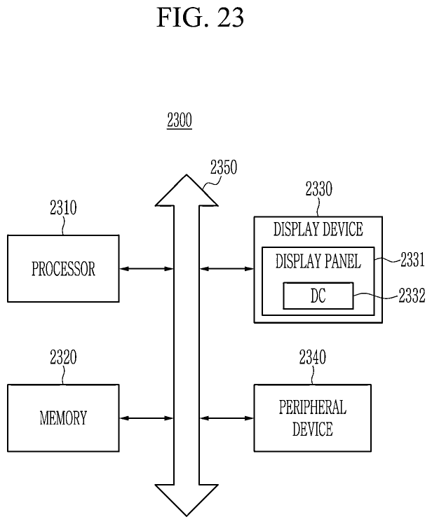

FIG. 23 is a view to explain a display system according to some example embodiments.

Referring to FIG. 23, a display system 2300 according to some example embodiments may include a processor 2310, a memory 2320, a display device 2330, and a peripheral device 2340 that are electrically connected to a system bus 2350.

The processor 2310 may control the input/output of a data from the memory 2320, the display device 2330, and the peripheral device 2340, and perform image processing of an image data transmitted or sent between the corresponding devices. The processor 2310 may be implemented as the host device described with reference to FIG. 1 to FIG. 22 according to some example embodiments. The processor 2310, through a plurality of signal channels, may transmit or send a first combination frame data that combines a part of a high resolution frame data and a part of a low resolution frame data and a second combination frame data that combines another part of the high resolution frame data and another part of the low resolution frame data to the display device 2330, respectively, and may transmit or send a combination frame data combining the high resolution frame data and the low resolution frame data to the display device 2330 through one signal channel. If the size of the combination frame data is less than the bandwidth of one signal channel, the processor 2310 may transmit or send the combination frame data to the display device 2330 through one signal channel.

The memory 2320 may include a volatile memory such as a dynamic random access memory (DRAM) and/or a non-volatile memory such as a flash memory. The memory 2320 may be composed of a DRAM, a phase-change random access memory (PRAM), a magnetic random access memory (MRAM), a resistive random access memory (ReRAM), a ferroelectric random access memory (FRAM), a NOR flash memory, a NAND flash memory, and a fusion flash memory (for example, a memory that combines a static random access memory (SRAM) buffer, a NAND flash memory, and a NOR interface logic). The memory 2320 may store an image data obtained from the peripheral device 2340 or a video signal processed by the processor 2310.

The display device 2330 may include a display panel 2331, and display the image data transmitted or sent through the system bus 2350 on the display panel 2331. The display device 2330 may be implemented as the display device described with reference to FIG. 1 to FIG. 22 according to some example embodiments. The display device 2330 may generate the low resolution frame data and the high resolution frame data from the combination frame data. The display panel 2331 may be a display panel according to some example embodiments. The display panel 2331 may include a driving circuit 2332. The driving circuit 2332 may provide signals in different ways to the first area that displays the high resolution frame data and the second area that displays the low resolution frame data. For example, the driving circuit 2332 may provide the gate signals to the gate lines in the first area according to the first driving method, and may provide the gate signals to the gate lines in the second area according to the second driving method. Compared to providing the gate signals to the gate lines in the second area according to the first driving method, according to some example embodiments, when providing the gate signals to the gate lines in the second area according to the second driving method, the period of providing the gate signals to the gate lines in the second area may be shortened. The driving circuit 2332 may be driven in a low bias state or turned off during some sections corresponding to a shortened period among scan periods within one frame period.

The peripheral device 2340 may be a device that converts a motion picture or a still image into an electrical signal, such as a camera, a scanner, or a webcam, but example embodiments are not limited thereto. The image data acquired through the peripheral device 2340 may be stored in the memory 2320 or displayed on the display panel 2331 in real-time.

The display system 2300, according to some example embodiments, may be provided in a mobile electron product such as a smart phone, but example embodiments are not limited thereto, and in some example embodiments, the display system 2300 may be provided in various types of electron products that display images.

In some example embodiments, each component, or combinations of two or more components described with reference to FIG. 1 to FIG. 23 may include or be implemented in one or more processing circuitries such as hardware including logic circuits; a hardware/software combination such as a processor executing software; or a combination thereof. For example, the processing circuitries more specifically may include, but are not limited to, a central processing unit (CPUT), a digital circuit, an arithmetic logic unit (ALU), a digital signal processor, a microcomputer, a field programmable gate array (FPGA), a System-on-Chip (SoC), a programmable or non-programmable logic device or array, a microprocessor, an application specific integrated circuit (ASIC), or the like.

While the above describes some example embodiments of the present inventive concepts, it is to be understood that the example embodiments are not limited thereto, but, on the contrary, are intended to cover various modifications and equivalent arrangements included within the spirit and scope of the appended claims.

What is claimed is:

1. A display device, comprising:
a host interface circuit configured to receive first frame data through a first signal channel and second frame data through a second signal channel;
a pixel array including a plurality of pixels, and a plurality of gate lines and a plurality of source lines connected to the plurality of pixels; and
an image processing circuit configured to process the first frame data and the second frame data such that the pixel array displays one image including a first area rendered with a first quality and a second area rendered with a second quality that is different from the first quality during one frame period.

2. The display device of claim 1, wherein the first frame data includes high resolution frame data rendered with the first quality, and the second frame data includes low resolution frame data rendered with the second quality.

3. The display device of claim 2, wherein the image processing circuit includes
a scaler configured to up-scale the second frame data, and
a mixer configured to mix the up-scaled second frame data and the first frame data.

4. The display device of claim 3, wherein the first frame data is received through the first signal channel in synchronization with a timing of the mixing of the up-scaled second frame data and the first frame data.

5. The display device of claim 2, wherein the second frame data includes pixel data representing the second area excluding the first area.

6. The display device of claim 1, wherein
the first frame data includes a portion of high resolution frame data rendered with the first quality and a portion of low resolution frame data rendered with the second quality, and
the second frame data includes another portion of the high resolution frame data rendered with the first quality and another portion of the low resolution frame data rendered with the second quality.

7. The display device of claim 6, wherein the image processing circuit includes
a decoder configured to receive the first frame data and the second frame data and outputs the high resolution frame data and the low resolution frame data,
a scaler configured to up-scale the low resolution frame data, and
a mixer configured to mix the up-scaled low resolution frame data and the high resolution frame data.

8. The display device of claim 7, wherein the decoder includes
a re-arrangement circuit configured to extract the high resolution frame data and the low resolution frame data within the first and second frame data based on a mapping information that directs placement of the high resolution frame data and the low resolution frame data within the first and second frame data, and
a buffer memory configured to temporarily store the high resolution frame data and send the high resolution frame data to the mixer in synchronization with a timing of the mixing of the up-scaled low resolution frame data and the high resolution frame data.

9. The display device of claim 7, wherein the second frame data and the first frame data are received simultaneously.

10. The display device of claim 1, wherein
the host interface circuit is further configured to receive a combination frame data combining the first frame data and the second frame data through one of the first signal channel and the second signal channel, and
the image processing circuit is further configured to generate the first frame data and the second frame data from the combination frame data.

11. The display device of claim 10, wherein the image processing circuit includes a decoder configured to receive the combination frame data and output the first frame data and the second frame data,
a scaler configured to up-scale the second frame data, and
a mixer configured to mix the up-scaled second frame data and the first frame data.

12. The display device of claim 11, wherein the decoder includes,
a re-arrangement circuit configured to extract the first frame data and the second frame data within the combination frame data based on a mapping information that directs placement of the first frame data and the second frame data within the combination frame data, and
a buffer memory configured to temporarily store the first frame data and send high resolution frame data to the mixer in synchronization with a timing of the mixing of the up-scaled second frame data and the first frame data.

13. The display device of claim 12, wherein:
the decoder further includes a pixel buffer memory configured to temporarily store a part of the second frame data, and
the re-arrangement circuit is further configured to store a part of the second frame data of which the placed order within the combination frame data and the displayed order on the pixel array are different in the pixel buffer memory.

14. The display device of claim 1, further comprising:
a timing controller configured to generate a data signal based on the first frame data and the second frame data, and
a driver circuit configured to generate a plurality of data voltages applied to the pixels positioned in the first area based on the first frame data, generate a plurality of data voltages applied to the pixels positioned in the second area based on the second frame data, and apply the plurality of gate signals to the plurality of gate lines so that an operation of applying gate signals to the gate lines connected to the pixels positioned in the first area and an operation of applying gate signals to the gate lines connected to the pixels positioned in the second area are different from each other.

15. A display system, comprising:
a host device configured to send first frame data rendered with a first quality and second frame data rendered with a second quality different from the first quality through a first signal channel and a second signal channel, or send combination frame data combining the first frame data and the second frame data through one of the first signal channel and the second signal channel; and
a display device configured to display an image of one frame based on the first frame data and the second frame data received through the first signal channel and the second signal channel, or display an image of one frame based on the combination frame data received through one of the first signal channel and the second signal channel.

16. The display system of claim 15, wherein the host device is further configured to send the combination frame data through one of the first signal channel and the second signal channel if a size of a line data of the combination frame data is less than a bandwidth of one of the first signal channel and the second signal channel.

17. The display system of claim 15, wherein
the display device is further configured to mix the first frame data and the second frame data, and
the host device is further configured to send the second frame data, and send the first frame data in synchronization with a mixing timing of the first frame data and the second frame data.

18. The display system of claim 15, wherein the second frame data includes data in an area that does not overlap an area in which the first frame data is displayed within an image of one frame.

19. The display system of claim 15, wherein
the display device further includes a sensor configured to track a position of a user's eyes and output tracking data to the host device, and
the host device is further configured to render an area corresponding to the position of the user's eyes with the first quality, and render a peripheral area of the area with the second quality based on the tracking data.

20. A display driving circuit, comprising:
a host interface circuit configured to receive first frame data through a first signal channel and receive second frame data through a second signal channel, or receive combination frame data combining the first frame data and the second frame data through one of the first signal channel and the second signal channel,
a decoder configured to receive the combination frame data and output the first frame data and the second frame data,
a scaler configured to up-scale the second frame data,
a mixer configured to output synthesis frame data mixing the up-scaled second frame data and the first frame data, and
a timing controller configured to generate a data signal based on the synthesis frame data.
